(19) United States
(12) Patent Application Publication
(10) Pub. No.: US 2024/0295647 A1
(43) Pub. Date: Sep. 5, 2024

(54) WAVEFORM ADAPTATION FOR RF SENSING

(71) Applicant: QUALCOMM Incorporated, San Diego, CA (US)

(72) Inventors: Weimin DUAN, San Diego, CA (US); Jing JIANG, San Diego, CA (US); Kangqi LIU, San Diego, CA (US)

(21) Appl. No.: 18/178,441

(22) Filed: Mar. 3, 2023

(51) Int. Cl. G01S 13/00; H04L 5/00

(52) U.S. Cl. CPC G01S 13/003; H04L 5/0007

(57) ABSTRACT

Apparatuses and methods for waveform adaptations in RF sensing are described. An apparatus is configured to operate in one of a wireless communications mode or a sensing mode. The wireless communications mode is associated with at least one of a communications or sensing waveform. The sensing mode is associated with at least one of the communications or the sensing waveform, and the sensing and communication waveforms are different. The apparatus is also configured to obtain an indication of a switch to operate in another of the wireless communications or sensing mode. The apparatus is further configured to switch to the other mode per the indication. Another apparatus is configured to operate in the wireless communications or the sensing mode, to provide an indication of a mode switch, and to switch to the other mode per the indication.

### TECHNICAL FIELD

The present disclosure relates generally to communication systems, and more particularly, to wireless communications utilizing sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delincates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The apparatus is also configured to obtain an indication of a switch to operate in another of the wireless communications mode or the sensing mode. The apparatus is further configured to switch to the another of the wireless communications mode or the sensing mode based on the indication.

In the aspect, the method includes operating in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The method also includes obtaining an indication of a switch to operate in another of the wireless communications mode or the sensing mode. The method further includes switching to the another of the wireless communications mode or the sensing mode based on the indication.

In an aspect of the disclosure, a method, a computer-readable medium, and an apparatus are provided. The apparatus is configured to operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The apparatus is also configured to provide, for a user equipment (UE), an indication of a switch to operate in another of the wireless communications mode or the sensing mode. The apparatus is further configured to switch to the another of the wireless communications mode or the sensing mode based on the indication.

In the aspect, the method includes operating in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The method also includes providing, for a UE, an indication of a switch to operate in another of the wireless communications mode or the sensing mode. The method further includes switching to the another of the wireless communications mode or the sensing mode based on the indication.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of waveform processing, in accordance with various aspects of the present disclosure.

FIG. 6 is a diagram illustrating an example of waveform processing, in accordance with various aspects of the present disclosure.

FIG. 7 is a diagram illustrating examples of Doppler scenarios for waveforms, in accordance with various aspects of the present disclosure.

FIG. 8 is a call flow diagram for wireless communications, in accordance with various aspects of the present disclosure.

FIG. 9 is a diagram illustrating an example of adaptation information and factors including a sensing environment, in accordance with various aspects of the present disclosure.

FIG. 10 is a call flow diagram for wireless communications, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks, such as a 5G NR network, may enable sensing measurements and operations for wireless devices. For example, a wireless communication network and/or a wireless device may utilize a specific waveform for communications and sensing. The use of such a waveform may provide for low cost, allow flexibility, and allow the re-use of sensing waveforms for multiple purposes. For instance, with radio detection and ranging (RADAR) waveforms, a UE may leverage a low-cost implementation to achieve high resolution sensing, while a UE and/or a base station may reuse RADAR waveforms for communication purposes, such as beam management.

However, from a communications perspective, orthogonal frequency division multiplexing (OFDM) may provide implementations for communications with better spectral efficiency over other waveforms, while from a performance-cost ratio perspective, analog RADAR waveforms may provide higher resolution in radio frequency (RF) sensing. Within analog RADAR waveforms, the waveform selection may also impact the RF sensing performance. As one example, at different use cases, operation scenarios, and/or, sensing environments, the RADAR waveform type/parameters may impact the RF sensing performance.

Various aspects relate generally to wireless communications systems and sensing operations for wireless devices. Some aspects more specifically relate to waveform adaptations for RF sensing. In one example, a UE may operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The UE may also obtain an indication of a switch to operate in another of the wireless communications mode or the sensing mode, and may further switch to the another of the wireless communications mode or the sensing mode based on the indication. In another example, a base station may operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The base station may provide, for a UE, an indication of a switch to operate in another of the wireless communications mode or the sensing mode, and may further switch to the another of the wireless communications mode or the sensing mode based on the indication. In aspects, the communications waveform may be an OFDM waveform, and the sensing waveform may be an analog RADAR waveform, and in some aspects, the OFDM waveform and/or the analog RADAR waveform may be used or communications and/or sensing operations.

Particular aspects of the subject matter described in this disclosure can be implemented to realize one or more of the following potential advantages. In some examples, by switching between communication and sensing modes of operation, the described techniques can be used to provide more accurate and efficient sensing data for targets through analog RADAR waveforms, while also providing improved spectral efficiency over other waveforms by utilizing OFDM wave forms for communications. In some examples, by further adapting communication and sensing waveforms, the described techniques can be used to increase accuracy and efficient sensing and communications according to different implementations of UEs/base stations, operating conditions of UEs/base stations, and/or a sensing environment associated with UEs/base stations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e.., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

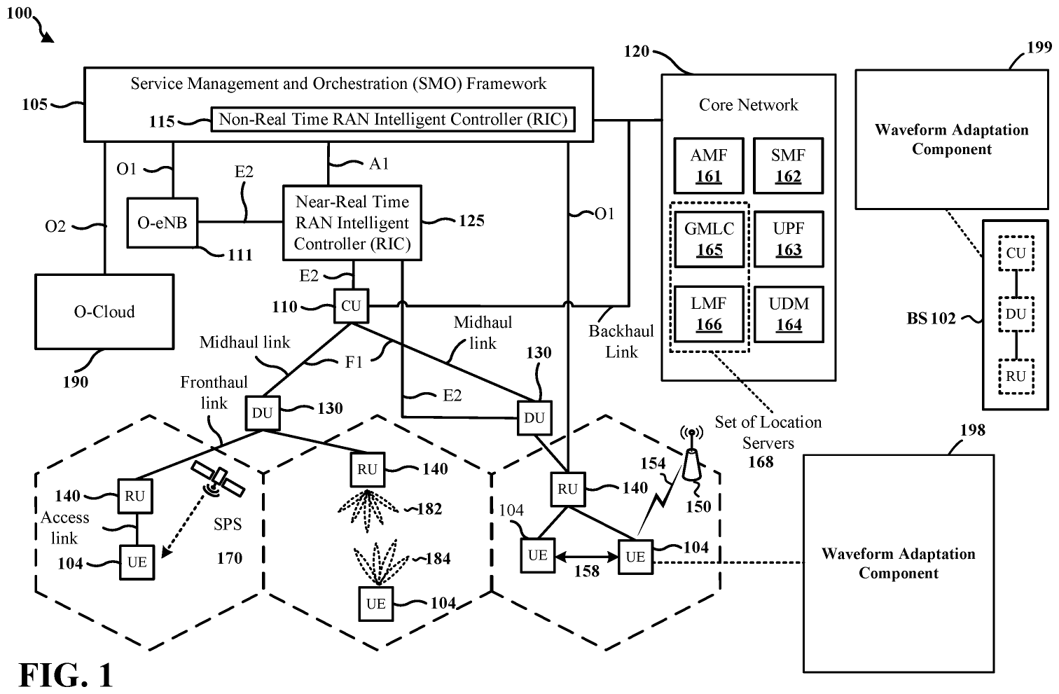

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e.., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e.., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a waveform adaptation component 198 (“component 198”) that may be configured to operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The component 198 may also be configured to obtain an indication of a switch to operate in another of the wireless communications mode or the sensing mode. The component 198 may be further configured to switch to the another of the wireless communications mode or the sensing mode based on the indication. The component 198 may be configured to select the sensing waveform based on at least one of an implementation of the UE, an operating condition of the UE, or a sensing environment associated with the UE. The component 198 may be configured to obtain adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and where to select the sensing waveform, the component 198 may be configured to select the sensing waveform based on the adaptation information. In certain aspects, the base station 102 may have a waveform adaptation component 199 (“component 199”) that may be configured to operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The component 199 may also be configured to provide, for a UE, an indication of a switch to operate in another of the wireless communications mode or the sensing mode. The component 199 may be further configured to switch to the another of the wireless communications mode or the sensing mode based on the indication. The component 199 may be configured to select the sensing waveform based on at least one of an implementation of the UE, an operating condition of the UE, or a sensing environment associated with the UE. The component 199 may be configured to provide adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and where the at least one adaptation factor includes at least one of a first distribution for target parameters, a dynamic range of the target parameters, clutter in the sensing environment, a power spectral density of the clutter, a second distribution or a dynamic range of a delay spread of the clutter, or a radio access technology (RAT), and where to select the sensing waveform, the component 199 may be configured to select the sensing waveform based on the adaptation information. That is, aspects provide for waveform adaptations for RF sensing that enable switching between communication and sensing modes of operation to provide more accurate and efficient sensing data for targets through analog RADAR waveforms, while also providing improved spectral efficiency over other waveforms by utilizing OFDM wave forms for communications, as well as additional adaptations for communication and sensing waveforms to increase accuracy and efficient sensing and communications according to different implementations of UEs/base stations, operating conditions of UEs/base stations, and/or a sensing environment associated with UEs/base stations.

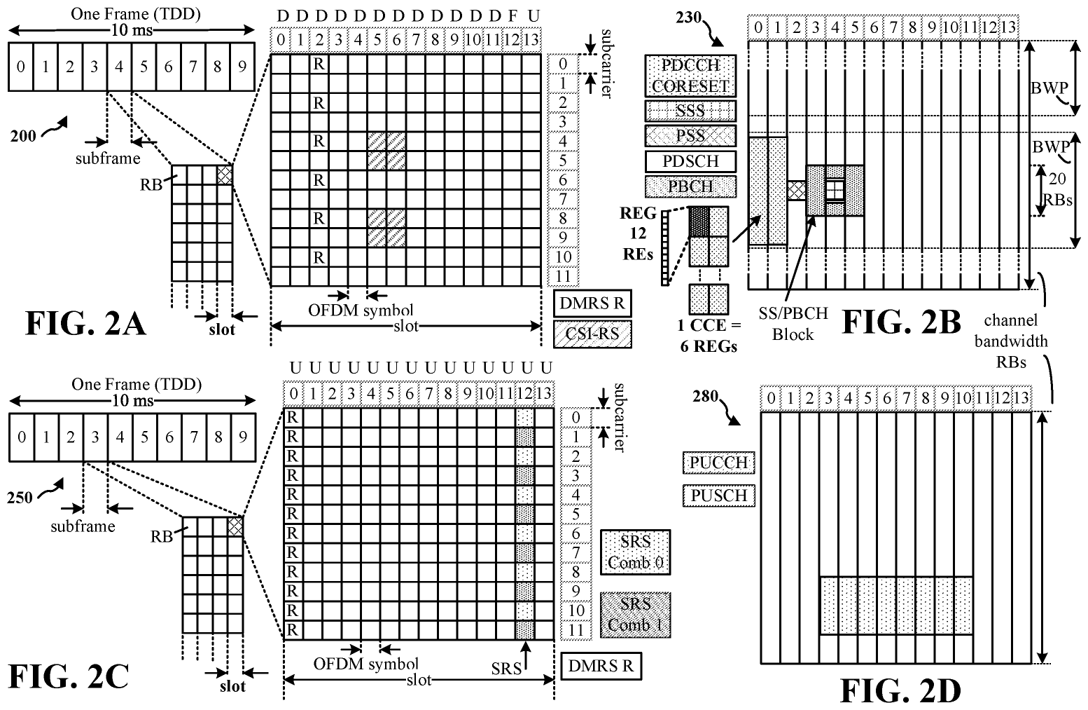

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies λ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e.., one or more HARQ ACK bits indicating one or more ACK and/or negative ACK (NACK)). The PUSCH carries data, and may additionally be used to carry a buffer status report (BSR), a power headroom report (PHR), and/or UCI.

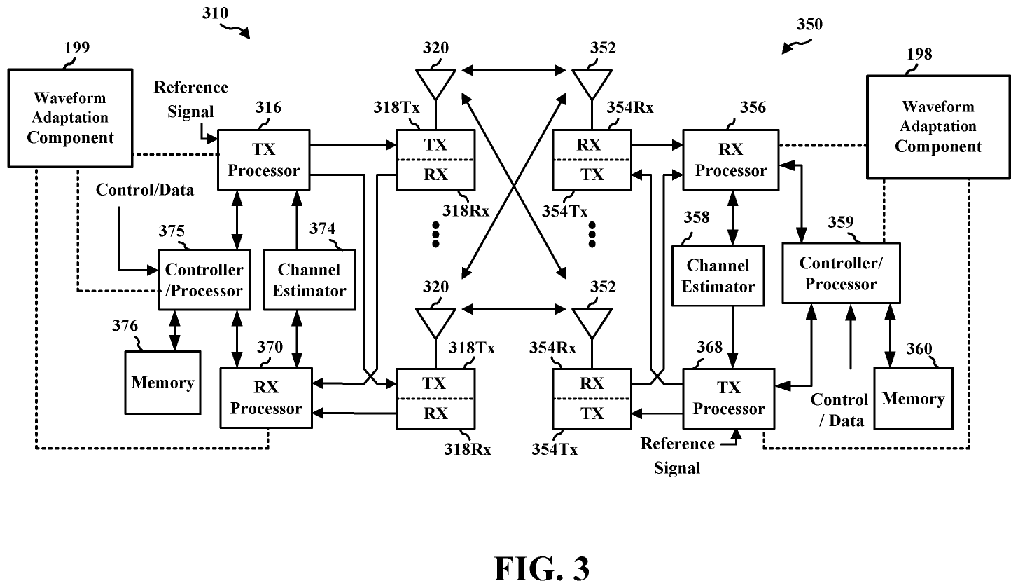

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ. concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving. rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ. priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

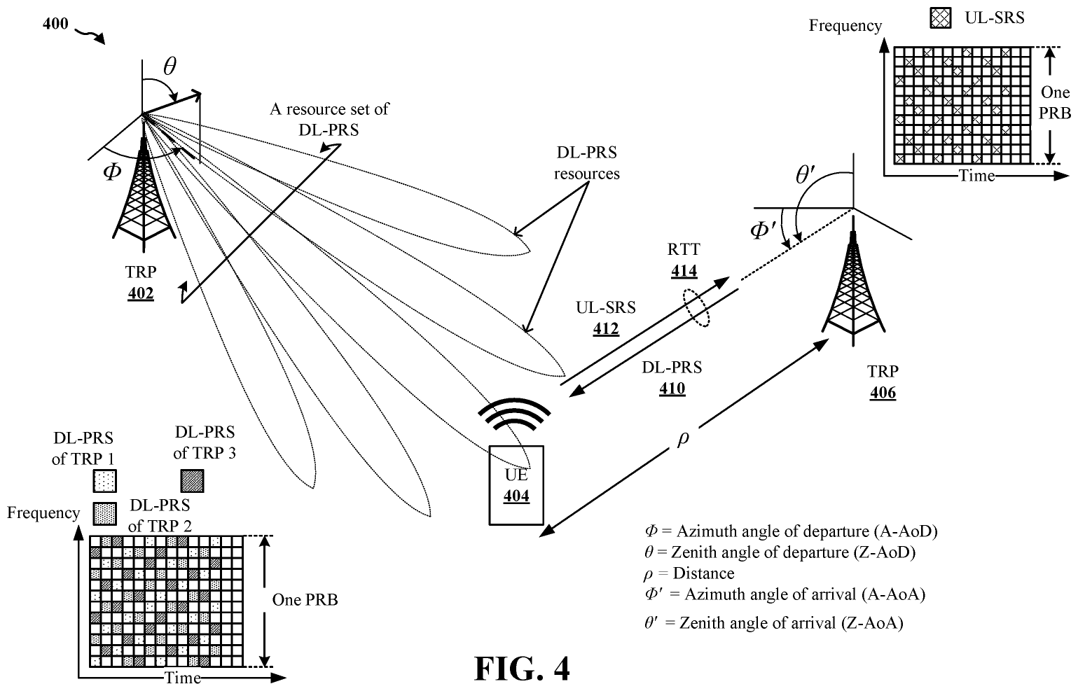

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}-T_{PRS_TX}|-|T_{SRS_TX}-T_{PRS_RX}∥. Accordingly, multi-RTT positioning may make use of the UE Rx-Tx time difference measurements (i.e.., |T_{SRS_TX}-T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e.., |T_{SRS_RX}-T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402,406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402,406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

RADAR waveforms, may include, without limitation, continuous wave (CW), or analog, waveforms and pulsed RADAR waveforms. CW waveforms may include, frequency modulated CW (FMCW) waveforms (e.g., linear FMCW waveforms such as continuous wave CW linear frequency modulation (LMF) waveforms including sawtooth, triangle, and/or the like; non-linear FMCW waveforms such as sinusoidal, multi-frequency, pseudorandom, and/or the like), as well as pulse modulated CW (PMCW) waveforms. Pulsed RADAR may include pulse-to-pulse modulation waveforms (e.g., frequency agility, stepped frequency, etc.) and intra-pulse modulation waveforms with frequency modulated (e.g., linear/non-linear frequency modulation) and phase modulated (e.g., bi-/poly-phase) subsets.

Wireless communication networks and/or a wireless devices may utilize a specific waveform for communications and sensing. The use of such a waveform may provide for low cost, allow flexibility, and allow the re-use of sensing waveforms for multiple purposes. For instance, with RADAR waveforms, a UE may leverage a low-cost implementation to achieve high resolution sensing, while a UE and/or a base station may reuse RADAR waveforms for communication purposes, such as beam management. However, from a communications perspective, OFDM may provide implementations for communications with better spectral efficiency over other waveforms, while from a performance-cost ratio perspective, analog RADAR waveforms may provide higher resolution in RF sensing. Within analog RADAR waveforms, the waveform selection may also impact the RF sensing performance. As one example, at different use cases, operation scenarios, and/or, sensing environments, the RADAR waveform type/parameters may impact the RF sensing performance.

The described aspects provide for waveform adaptations for RF sensing that enable switching between communication and sensing modes of operation to provide more accurate and efficient sensing data for targets through analog RADAR waveforms, including, but without limitation, linear FMCW waveforms, while also providing improved spectral efficiency over other waveforms by utilizing OFDM wave forms for communications, as well as additional adaptations for communication and sensing waveforms to increase accuracy and efficient sensing and communications according to different implementations of UEs/base stations, operating conditions of UEs/base stations, and/or a sensing environment associated with UEs/base stations. For instance, aspects herein provide for a UE that may be configured to operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. A wireless communication mode may be an operational mode configured for data communications to be provided to other devices on and/or of a wireless communications network, and a communication waveform may be a waveform by which the data communications may be provided (e.g., OFDM). A sensing mode may be an operational mode configured for sensing targets in an environment, and a sensing waveform may be a waveform by which the sensing of targets may be performed (e.g., RADAR). For wireless communications modes, adaptations may be utilized in the context of joint communication and sensing (JCS) operations, and in sensing modes, adaptations may be utilized in the context of waveform types, waveform characteristics, different waveform bands, and/or the like. The UE may also be configured to obtain an indication of a switch to operate in another of the wireless communications mode or the sensing mode, and to switch to the another of the wireless communications mode or the sensing mode based on the indication. Additionally, aspects are applicable to 5G NR and may also be extended to 5G Enhanced and 6G applications.

While various aspects may be described in the context of RADAR and FMCW waveforms for descriptive and illustrative purposes, aspects are not so limited and may be applicable to other types of resources and operations, as would be understood by persons of skill in the relevant art(s) having the benefit of this disclosure.

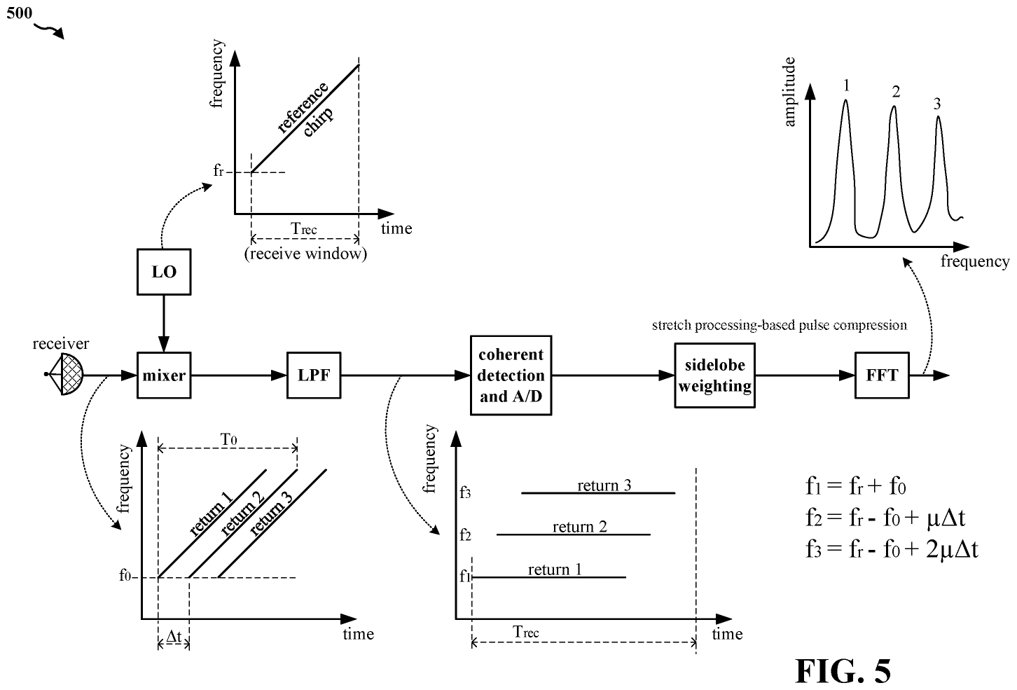

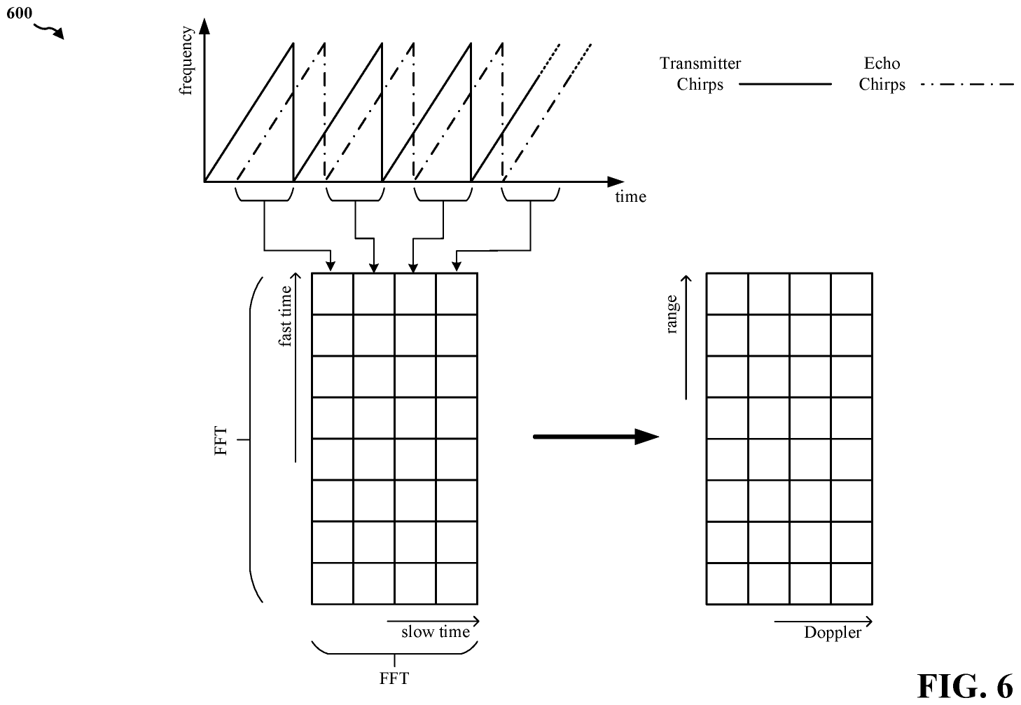

FIGS. 5, 6 will now be described. FIG. 5 is a diagram 500 illustrating an example of waveform processing, in various aspects. FIG. 6 is a diagram 600 illustrating an example of waveform processing, in various aspects.

Linear FMCW waveforms, also wideband FMCW waveforms, may be referred to as complex sinusoids whose frequency increases linearly with time. Such waveforms may be characterized according to fₜ=f_{c}+(B/T)*t, where f_{c} is the carrier frequency, B is the signal bandwidth, and t is an element for time in the set of [0, T]. Processing of linear FMCW waveforms is described, by way of example, for diagram 500 of FIG. 5, with some “beat signal” aspects of the processing being described, by way of example, for diagram 600 of FIG. 6.

At the receiver shown in diagram 500, the received signal may be mixed with the transmitted chirp, which may result in a complex sinusoid that may be referred to as a “beat signal.” The process of obtaining the beat signal may be implemented in the RF domain by a mixer, which may be followed by a bandpass filter (e.g., a low-pass filter (LPF). The beat signal frequency may be described according to f_{b}=f_{R}+f_{D}. where f_{R}=2*R*B/(T*c) is the range frequency, and f_{D}=(2v/c)*f_{c} is the Doppler frequency, where R is the target range, c is the speed of light, and v is the radial speed.

The estimation of the beat frequency may be implemented in the digital domain through a two-dimensional (2-D) FFT, as shown in diagram 600, where it holds that (2*Rmax/c)<<T, and thus f_{R}<<B (where Rmax is the maximum detected range). Also, it may hold that f_{D}<<f_{R}. and thus, the beat frequency may be much smaller than signal bandwidth B. Therefore, it follows that a low-speed analog-to-digital converter (ADC) may be used to sample the beat signal, which may result in a low cost of implementation (e.g., from 100s MHz to 10 or 10s MHz). The time during one period or “chirp” may be referred to as the “fast time,” while the time across multiple periods or chirps may be referred to as the “slow time.” In some use cases, f_{D} may be treated as constant within each chirp, and thus by the FFTs on the beat signal alone, the fast time can identify the range frequency f_{R}, and the corresponding target's range R, where R=c*f_{R}*T/2B. In some cases, a second FFT operation alone on the slow time (e.g., assuming the range frequency f_{R} is the same across the slow time) may obtain the target's Doppler.

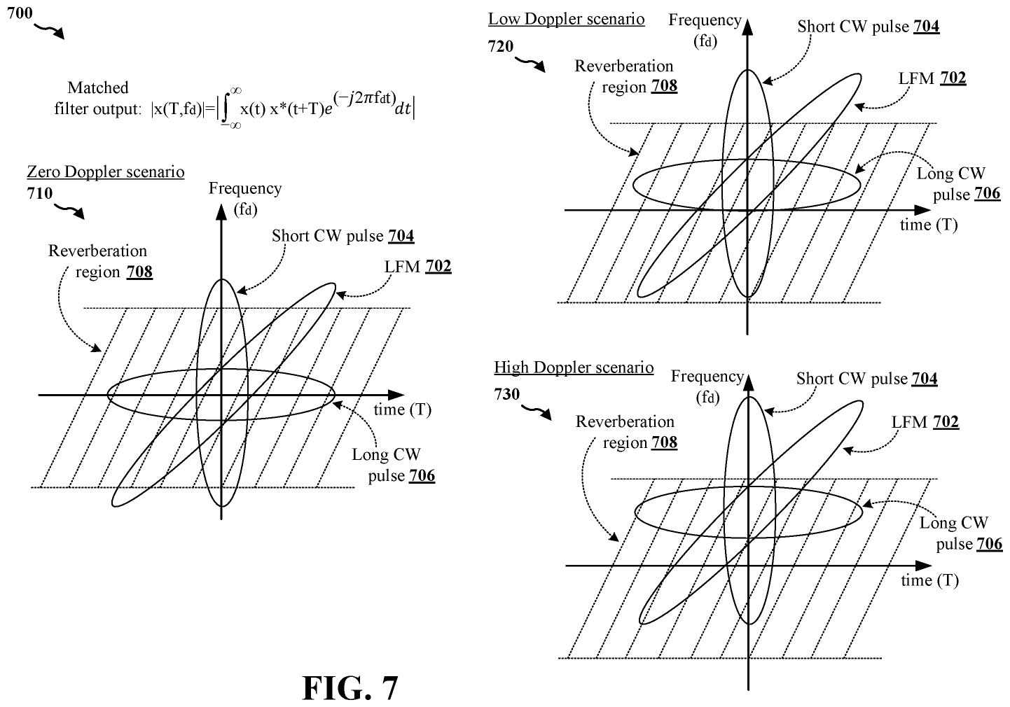

FIG. 7 is a diagram 700 illustrating examples of Doppler scenarios for waveforms, in various aspects. The goodness of a given waveform may be based on its range and Doppler resolutions, which may be analyzed in the context of the ambiguity function of the waveform. A RADAR ambiguity function may represent the modulus of the matched filter output described in diagram 700. The RADAR ambiguity function may describe the interference caused by the range and/or Doppler shift of a target when compared to a reference target of equal RADAR cross-section (RCS). To maximize the difference of echoes (e.g., the integral squared error), the ambiguity function may be minimized.

Diagram 700 also illustrates example configurations of Doppler scenarios for waveforms utilized in target detection for a rich scattering/cluttering environment: a configuration 710 for a zero Doppler scenario, a configuration 720 for a low Doppler scenario, and a configuration 730 for a high Doppler scenario. Each illustrated configuration is shown in the context of a FMCW pulse 702, a short CW pulse 704, and a long CW pulse 706, as well as a reverberation region 708 associated with an ambiguity area of the different illustrated pulses.

In the configuration 710 for the zero Doppler scenario and the configuration 720 for the low Doppler scenario, e.g., where the target Doppler is zero or relatively small, compared with long unmodulated CW pulses such as the long CW pulse 706, the FMCW pulse 702 has smaller ambiguity area, and thus a lower interference impact for sensing operations. When the target Doppler is large as in the configuration 730 for the high Doppler scenario, compared with the FMCW pulse 702 and short unmodulated CW pulses such as the short CW pulse 704, long unmodulated CW pulses such as the long CW pulse 706 have a smaller ambiguity area, and thus a lower interference impact for sensing operations.

Aspects herein enable for multiple waveform options in sensing operations to which a UE and/or base station may select and switch, e.g., enable waveform adaptations based on different scenarios, and provide for a more robust sensing as one waveform option may not handle all cases accurately and/or efficiently.

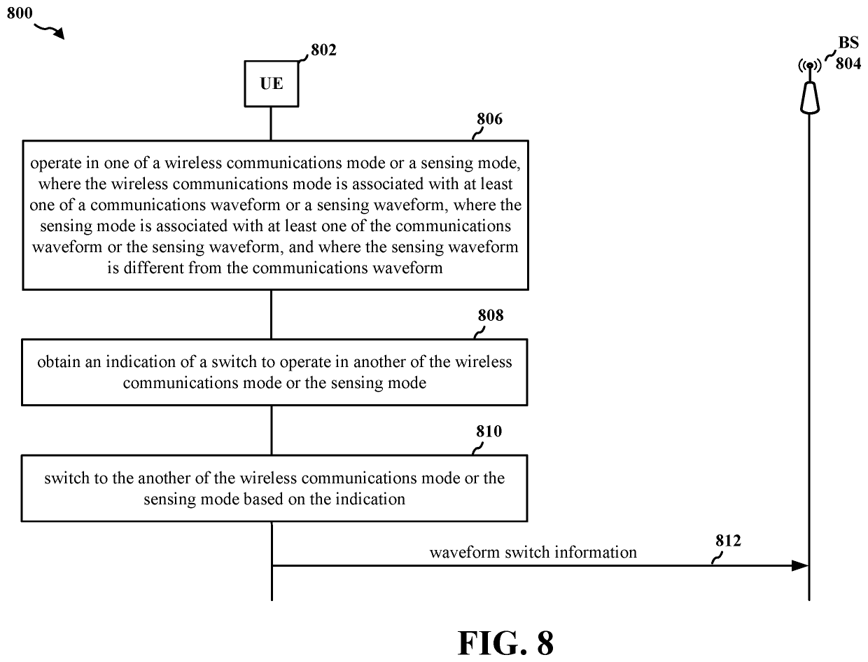

FIG. 8 is a call flow diagram 800 for wireless communications, in various aspects. Call flow diagram 800 illustrates waveform adaptations for RF sensing by a UE (e.g., a UE 802) that may communicate with and/or performing sensing operations with/without a network node (a base station 804, such as a gNB or other type of base station, by way of example, as shown). Aspects described for the base station 804 may be performed by the base station in aggregated form and/or by one or more components of the base station 804 in disaggregated form. Additionally, or alternatively, the aspects may be performed by the UE 802 autonomously, in addition to, and/or in lieu of, operations of the base station 804.

In the illustrated aspect, the UE 802 may be configured to operate (at 806) in one of a wireless communications mode or a sensing mode. The wireless communications mode may be associated with at least one of a communications waveform or a sensing waveform, and the sensing mode may be associated with at least one of the communications waveform or the sensing waveform (where the sensing waveform is different from the communications waveform, in aspects). For instance, the UE 802 may be configured to operate (at 806) in a wireless communications mode to communicate with a network node, e.g., the base station 804, via OFDM waveforms. The OFDM waveforms may be cyclic prefix (CP) OFDM (CP-OFDM) waveforms, DFT-s-OFDM waveforms, and/or the like, in aspects, and CP-OFDM waveforms may include a time gap subsequent to CP portions thereof. Additionally, the UE 802 may be configured to operate (at 806) in a sensing mode to sense targets, with (e.g., bistatic sensing) or without (e.g., monostatic sensing) a network node (e.g., the base station 804), via analog RADAR waveforms, as described herein (e.g., Linear FMCW waveforms, short CW waveforms, long CW waveforms, and/or the like, such as those described above with respect to FIG. 7). Further the UE 802 may be configured to operate (at 806) in a wireless communications mode with sensing waveforms and/or in a sensing mode with communications waveforms, in some aspects.

The UE 802 may be configured to obtain (at 808) an indication of a switch to operate in another of the wireless communications mode or the sensing mode. For instance, in one configuration, the UE 802 may autonomously and/or via user input reach a determination (e.g., obtain at 808) to switch its mode of operation between communications and sensing, in some aspects. In other aspects, the UE 802 may be configured to receive (e.g., obtain at 808) the indication from the base station 804 via signaling such as RRC signaling, a medium access control (MAC) control element (MAC-CE), DCI, etc. In aspects, the indication of the switch that is obtained (at 808) may be to switch from the wireless communications mode to the sensing mode, and the indication may include, without limitation, a channel associated with the switch, a sensing waveform type, sensing waveform type parameters, a usage for subsequent transmissions associated with the sensing waveform, and/or the like.

In aspects, as described herein, the UE 802 may be configured to obtain adaptation information. In aspects, adaptation information may information associated with waveform adaptations for RF sensing, and may include one or more adaptation factors that correspond to different characteristics of sensing nodes, sensing environments, wireless communication networks, and/or the like, that impact efficacy of various sensing waveforms. The UE 802 may autonomously (e.g., dynamically) and/or via user input obtain adaptation information and/or may be configured to receive adaptation information from the base station 804 via signaling such as RRC signaling. a medium access control (MAC) control element (MAC-CE), DCI, etc., which may be dynamically performed, in aspects. For instance, the UE 802 may be configured to obtain adaptation information based on an adaptation factor(s) that is associated with one or more of the sensing environment of the UE 802, sensing target characteristics, a hardware capability of the UE 802, a power budget of the UE 802, a transmission power capability of the UE 802, a maximum power emission/adjacent channel leakage ratio (ACLR) for the UE 802, and/or the like. In aspects, the UE 802 may obtain/receive at least a portion of the adaptation information from the base station 804 (e.g., a network node). In such aspects, the adaptation factor(s) may include, but are not limited to, a first distribution for target parameters, a static/dynamic range of the target parameters, clutter in the sensing environment, a power spectral density of the clutter (e.g., which may aid the waveform optimization to reduce the ambiguity area for lower interference impact), a second distribution or a static/dynamic range of a delay spread of the clutter, an activity of a RAT, and/or the like.

In aspects, as described herein, the UE 802 may be configured to select communications and/or sensing waveforms. The selection may be for adaptation of waveforms, and may be performed according to different scenarios and/or based on adaptation information. For instance, the UE 802 may be configured to select the sensing waveform based on an implementation of the UE 802, an operating condition of the UE 802, a sensing environment associated with the UE 802, and/or the like, in aspects. In some aspects, the UE 802 may be configured to select the sensing waveform as a CW LMF waveform based on a target Doppler that is less than, or less than or equal to, a Doppler threshold. In some aspects, the UE 802 may be configured to select the sensing waveform as a long unmodulated CW waveform based on a target Doppler that is greater than, or greater than or equal to, a Doppler threshold, where the Doppler threshold may be associated with, and may be greater than, that of a CW LMF waveform and a short unmodulated CW waveform.

In aspects, the UE 802 may be configured to select the sensing waveform as a short pulse waveform based on monostatic sensing being, or to be, performed at the UE 802. For instance, if the UE 802 does not support full duplex RF sensing (e.g., does not support bistatic sensing, but supports monostatic sensing), a short pulse waveform, such as a short CW pulse waveform, may be selected for sensing operations instead of a long CW pulse waveform.

Additionally, the UE 802 may be configured to select the sensing waveform from one or more different bands. In some aspects, the UE 802 may be configured to select the sensing waveform, from one or more different bands based on a cost-performance ratio, as a CW LMF waveform in a first band having a first bandwidth or as a pulse waveform in a second band having a second bandwidth (e.g., where the first bandwidth is larger than the second bandwidth). As one example, in a high band with a large bandwidth, such as FR2, a linear FMCW waveform may be selected based on a high cost-performance ratio. As another example, in a lower band with low to medium bandwidth, a pulse radar waveform may be selected by reusing the hardware for communication operations.

In some aspects, the UE 802 may be configured to select the sensing waveform as a CW LMF waveform for an outdoor environment or as a pulse waveform in an indoor environment (e.g., as the sensing environment). As on example, for indoor use cases, the operation range may be small, and the signal power to be utilized may be much lower than outdoor use cases; therefore, a pulse radar waveform may be considered and selected. For outdoor use cases, the operation range may be large, and the signal power for performance may be higher than indoor use cases; therefore; a linear FMCW waveform may be considered and selected. It should be noted that linear FMCW waveforms may transmit with long duration and maintain a high resolution, while pulse radar waveforms may be transmitted with short durations to achieve high resolution, and this may result in a much higher peak power if used for long range sensing.

The UE 802 may be configured to switch (at 810) to the another of the wireless communications mode or the sensing mode based on the indication. For instance, the UE 802 may be configured to switch (at 810) from the wireless communications mode (operated in at 806) to the sensing mode based on the indication, and the UE 802 may be configured to switch (at 810) from the sensing mode (operated in at 806) to the wireless communications mode based on the indication. In aspects, the UE 802 may be configured to switch (at 810) subsequent to a time gap, where the time gap is associated with, and in addition to, a CP duration and is associated with transmission switching and/or reception switching. For instance, the UE 802 and/or the base station 804 may not be expected to perform, or be capable of, processing/receiving the switched-to waveform during the switching gap (e.g., for Tx switching and/or Rx switching). In other aspects, the UE 802 may be configured to switch (at 810) during the CP duration and without the time gap. For instance, the UE 802 and/or the base station 804 may be expected to perform, or be capable of, processing/receiving the switched-to waveform during or within the CP duration, e.g., of CP-OFDM or DFT-s-OFDM waveforms. In such cases, the gap may not be included. As one example, if the waveform switches from an RF sensing mode to a communications mode, the OFDM symbol after the CP may be acceptably impacted in terms of communication performance, and/or the impacted OFDM symbol may be specially treated in the signal processing. Likewise, for such cases, the impact for RF sensing may be acceptable with respect to accuracy, performance, and/or the like.

The UE 802 may be configured to transmit or provide, e.g., to the base station 804, waveform switch information 812. The waveform switch information 812 may be associated with any information related to the switch (at 810), and may indicate and/or include at least a portion of the information described above for switched waveforms, channels, waveform types and/or parameters, subsequent transmissions, waveform adaptation, and/or the like, in aspects. In some aspects, the waveform switch information 812 may be transmitted/provided from the UE 802 to the base station 804 as a response or acknowledgement to receiving/obtaining (at 808) the indication of the switch to operate in another of the wireless communications mode or the sensing mode, while in other aspects the waveform switch information 812 may be transmitted/provided as informational.

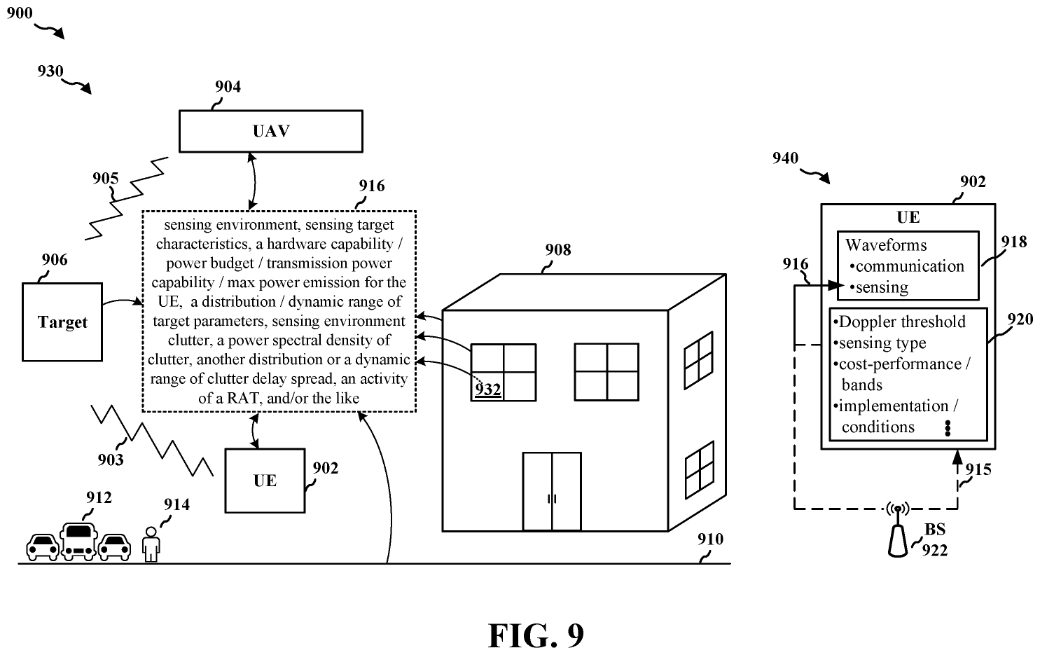

FIG. 9 is a diagram 900 illustrating an example of adaptation information and factors including a sensing environment, in various aspects. In aspects, diagram 900 illustrates a sensing environment 930 and selection of a waveform/waveform adaptations based on at least one of an adaptation factor 916 for RF sensing by a UE (e.g., a UE 902, which may be an unmanned aerial vehicle (UAV) 904 in some aspects) for sensing (e.g., 903, 905, respectively) a target 906. That is, the UE 902 may select a sensing waveform based on adaptation information and factors, including those associated with the sensing environment 930 in which the UE 902 may be located.

In aspects, a sensing environment may be an environment in which a sensing node resides and that may be sensed by the sensing node through a sensing mode thereof. The sensing environment 930 may represent a rich scattering/cluttering environment and may include, without limitation, buildings 908 or equivalent structures (e.g., including exterior structure for outdoor environments, interior spaces for indoor environments (e.g., an indoor sensing environment 932), etc.), surface features 910 (e.g., pavement such as streets, sidewalks, bridges, signs/billboards, and/or other non-building infrastructure, trees, terrain, etc.), vehicles 912, persons 914, and/or the like. A receiver (Rx) of the UE 902 (and/or the UAV 904) may receive clutter (or echo) during sensing operations due to the signal from the associated transmitter (Tx) being reflected by portions of the sensing environment 930. For example, a transmitted sensing signal/waveform may be reflected from the building 908, the surface features 910, the vehicles 912, the persons 914, and/or the like, and clutter from signal reflections may impair, or interfere with, signals in sensing and communications to different degrees based on the RCS and reflectivity of the non-target objects in the sensing environment. As one example, the façade of the building 908 may include some materials such as concrete, brick, etc., that reflect transmitted signals/waveforms for sensing, as well as other materials such as types of glass, metals, etc., that may reflect higher levels of transmitted signals/waveforms for sensing. Adaptation information for such adaptation factor(s) 916 may be obtained by, provided for, the UE 902 (and/or the UAV 904).

In aspects, the adaptation information may be provided by the base station 922 in configuration 940 and received by the UE 902 (and/or the UAV 904) as network-assisted/aided adaption information. In such aspects, the adaptation factor(s) 916 on which the network-assisted/aided adaptation information is based may include, but is not limited to, a first distribution for target parameters, a dynamic range of the target parameters, clutter in the sensing environment, a power spectral density of the clutter, a second distribution or a dynamic range of a delay spread of the clutter, an activity of a RAT, and/or the like, e.g., in the sensing environment 930. The adaptation information may also indicate to the UE 902 (and/or the UAV 904) that the sensing environment 930 is a rich scattering/cluttering environment.

In some aspects, the base station 922 may provide for/transmit to the UE 902 an indication 915 of a switch to operate in the wireless communications mode from the sensing mode or in the sensing mode from the wireless communications mode. The adaptation information based on the adaptation factor(s) 916, obtained by the UE 902 and/or provided by the base station 922, may be utilized by the UE 902 for waveform selections from waveform configurations 918 and mode switches, as described herein. Additionally, the waveform selections and mode switches may be based on implementation and condition information 920, which may include, without limitation, an implementation of the UE 902, an operating condition of the UE 902, other aspects of the sensing environment 930 associated with the UE 902, a target Doppler that is less than, or less than or equal to, a Doppler threshold, a target Doppler that is greater than, or greater than or equal to, a Doppler threshold, support of the UE 902 for mono-/bi-static sensing operations, and/or the like.

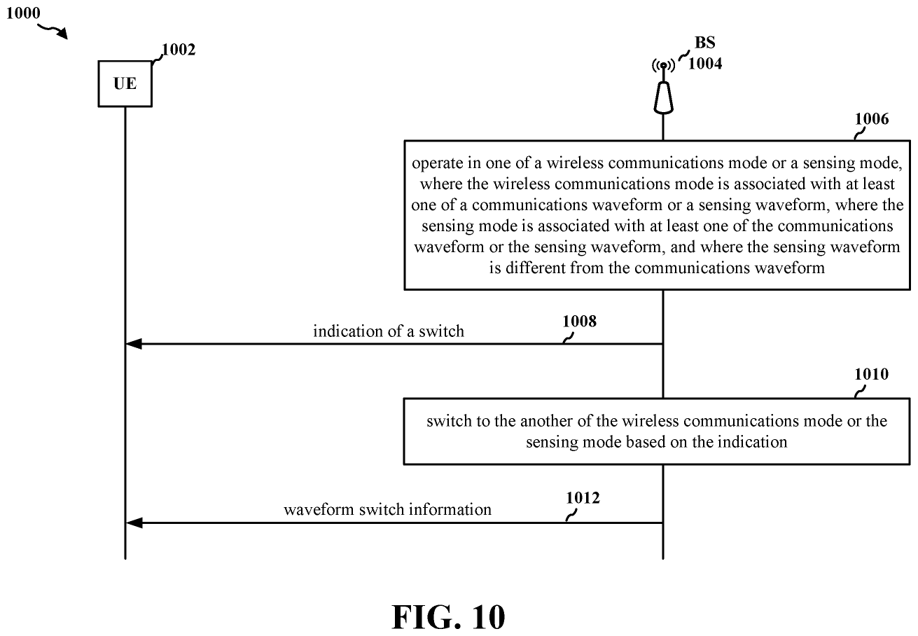

FIG. 10 is a call flow diagram 1000 for wireless communications, in various aspects. Call flow diagram 1000 illustrates waveform adaptations for RF sensing by a base station (e.g., a base station 1004, such as a gNB or other type of base station, by way of example, as shown) that may communicate with and/or performing sensing operations with/without a UE (a UE 1002). Aspects described for the base station 1004 may be performed by the base station in aggregated form and/or by one or more components of the base station 1004 in disaggregated form. Additionally, or alternatively, the aspects may be performed by the UE 1002 autonomously, in addition to, and/or in lieu of, operations of the base station 1004.

In the illustrated aspect, the base station 1004 may be configured to operate (at 1006) in one of a wireless communications mode or a sensing mode. The wireless communications mode may be associated with at least one of a communications waveform or a sensing waveform, and the sensing mode may be associated with at least one of the communications waveform or the sensing waveform (where the sensing waveform is different from the communications waveform, in aspects). For instance, the base station 1004 may be configured to operate (at base station 1004 06) in a wireless communications mode to communicate with a UE, e.g., the UE 1002. via OFDM waveforms. The OFDM waveforms may be cyclic prefix (CP) OFDM (CP-OFDM) waveforms, DFT-s-OFDM waveforms, and/or the like, in aspects, and CP-OFDM waveforms may include a time gap subsequent to CP portions thereof. Additionally, the base station 1004 may be configured to operate (at 1006) in a sensing mode to sense targets, with (e.g., bistatic sensing) or without (e.g., monostatic sensing) a UE (e.g., the UE 1006), via analog RADAR waveforms, as described herein (e.g., Linear FMCW waveforms, short CW waveforms, long CW waveforms, and/or the like, such as those described above with respect to FIG. 7). Further the base station 1004 may be configured to operate (at 1006) in a wireless communications mode with sensing waveforms and/or in a sensing mode with communications waveforms, in some aspects.

The base station 1004 may be configured to provide/transmit an indication 1008 of a switch to operate in another of the wireless communications mode or the sensing mode. For instance, the base station 1004 may be configured to provide/transmit the indication 1008 for the UE 1002 via signaling such as RRC signaling, a medium access control (MAC) control element (MAC-CE), DCI, etc. In aspects, the indication 1008 of the switch that is provided/transmitted may be to switch from the wireless communications mode to the sensing mode, and the indication may include, without limitation, a channel associated with the switch, a sensing waveform type, sensing waveform type parameters, a usage for subsequent transmissions associated with the sensing waveform, and/or the like.

In aspects, as described herein, the base station 1004 may be configured to provide/transmit adaptation information. The base station 1004 may be configured to provide/transmit the adaptation information for the UE 1002 via signaling such as RRC signaling, a medium access control (MAC) control element (MAC-CE), DCI, etc., which may be dynamically performed, in aspects. For instance, the base station 1004 may be configured to obtain and then provide/transmit the adaptation information based on an adaptation factor(s) that is associated with one or more of the sensing environment of the UE 1002, sensing target characteristics, a hardware capability of the UE 1002, a power budget of the UE 1002, a transmission power capability of the UE 1002, a maximum power emission/adjacent channel leakage ratio (ACLR) for the UE 1002, a first distribution for target parameters, a static/dynamic range of the target parameters, clutter in the sensing environment, a power spectral density of the clutter (e.g., which may aid the waveform optimization to reduce the ambiguity area for lower interference impact), a second distribution or a static/dynamic range of a delay spread of the clutter, an activity of a RAT, and/or the like.

In aspects, as described herein, the base station 1004 may be configured to select communications and/or sensing waveforms. The selection may be for adaptation of waveforms, and may be performed according to different scenarios and/or based on adaptation information. For instance, the base station 1004 may be configured to select the sensing waveform based on an implementation of the UE 1002, an operating condition of the UE 1002, a sensing environment associated with the UE 1002, and/or the like, in aspects. In some aspects, the base station 1004 may be configured to select the sensing waveform as a CW LMF waveform based on a target Doppler that is less than, or less than or equal to, a Doppler threshold. In some aspects, the base station 1004 may be configured to select the sensing waveform as a long unmodulated CW waveform based on a target Doppler that is greater than, or greater than or equal to, a Doppler threshold, where the Doppler threshold may be associated with, and may be greater than, that of a CW LMF waveform and a short unmodulated CW waveform.

In aspects, the base station 1004 may be configured to select the sensing waveform as a short pulse waveform based on monostatic sensing being, or to be, performed at the UE 1002. For instance, if the UE 1002 does not support full duplex RF sensing (e.g., does not support bistatic sensing, but supports monostatic sensing), a short pulse waveform, such as a short CW pulse waveform, may be selected for sensing operations instead of a long CW pulse waveform.

Additionally, the base station 1004 may be configured to select the sensing waveform from one or more different bands. In some aspects, the base station 1004 may be configured to select the sensing waveform, from one or more different bands based on a cost-performance ratio, as a CW LMF waveform in a first band having a first bandwidth or as a pulse waveform in a second band having a second bandwidth (e.g., where the first bandwidth is larger than the second bandwidth). As one example, in a high band with a large bandwidth, such as FR2, a linear FMCW waveform may be selected based on a high cost-performance ratio. As another example, in a lower band with low to medium bandwidth, a pulse radar waveform may be selected by reusing the hardware for communication operations.

In some aspects, the base station 1004 may be configured to select the sensing waveform as a CW LMF waveform for an outdoor environment or as a pulse waveform in an indoor environment. As on example, for indoor use cases, the operation range may be small, and the signal power to be utilized may be much lower than outdoor use cases; therefore, a pulse radar waveform may be considered and selected. For outdoor use cases, the operation range may be large, and the signal power for performance may be higher than indoor use cases; therefore; a linear FMCW waveform may be considered and selected. It should be noted that linear FMCW waveforms may transmit with long duration and maintain a high resolution, while pulse radar waveforms may be transmitted with short durations to achieve high resolution, and this may result in a much higher peak power if used for long range sensing.

The base station 1004 may be configured to switch (at 1010) to the another of the wireless communications mode or the sensing mode based on the indication. For instance, the base station 1004 may be configured to switch (at 1010) from the wireless communications mode (operated in at 1006) to the sensing mode based on the indication, and the base station 1004 may be configured to switch (at 1010) from the sensing mode (operated in at 1006) to the wireless communications mode based on the indication. In aspects, the base station 1004 may be configured to switch (at 1010) subsequent to a time gap, where the time gap is associated with, and in addition to, a CP duration and is associated with transmission switching and/or reception switching. For instance, the UE 1002 and/or the base station 1004 may not be expected to perform, or be capable of, processing/receiving the switched-to waveform during the switching gap (e.g., for Tx switching and/or Rx switching). In other aspects, the base station 1004 may be configured to switch (at 1010) during the CP duration and without the time gap. For instance, the UE 1002 and/or the base station 1004 may be expected to perform, or be capable of, processing/receiving the switched-to waveform during or within the CP duration, e.g., of CP-OFDM or DFT-s-OFDM waveforms. In such cases, the gap may not be included. As one example, if the waveform switches from an RF sensing mode to a communications mode, the OFDM symbol after the CP may be acceptably impacted in terms of communication performance, and/or the impacted OFDM symbol may be specially treated in the signal processing. Likewise, for such cases, the impact for RF sensing may be acceptable with respect to accuracy, performance, and/or the like.

The base station 1004 may be configured to transmit or provide, e.g., to the UE 1002, waveform switch information 1012. The waveform switch information 1012 may be associated with any information related to the switch (at 1010), and may indicate and/or include at least a portion of the information described above for switched waveforms, channels, waveform types and/or parameters, subsequent transmissions, waveform adaptation, and/or the like, in aspects. In some aspects, the waveform switch information 1012 may be transmitted/provided for the UE 1002 from the base station 1004 as a confirmation of the indication 1008 of the switch to operate in another of the wireless communications mode or the sensing mode, or of the switch (at 1010) itself, while in other aspects the waveform switch information 1012 may be transmitted/provided as informational.

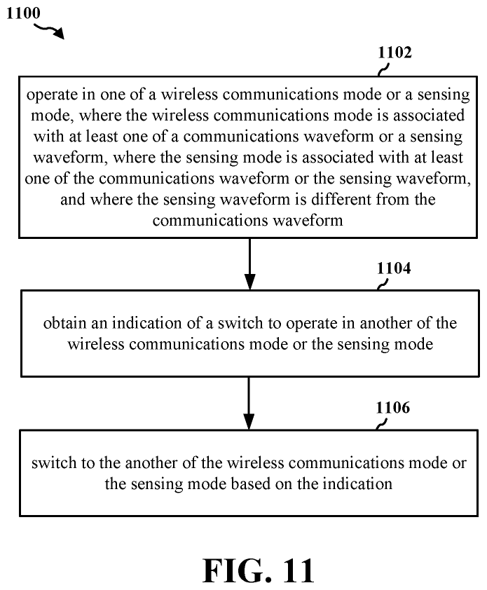

FIG. 11 is a flowchart 1100 of a method of wireless communication, in various aspects. The method may be performed by a UE (e.g., the UE 104, 404, 802, 902, 1002; the apparatus 1504). In some aspects, the method may include aspects described in connection with the communication flow in FIG. 8 and/or aspects described in FIGS. 4-7 and 9. The method provides for waveform adaptations in RF sensing that enables a UE to switch between communication and sensing modes of operation to provide more accurate and efficient sensing data for targets through analog RADAR waveforms, including, but without limitation, linear FMCW waveforms, and also to provide improved spectral efficiency over other waveforms by utilizing OFDM wave forms for communications, as well as additional adaptations for communication and sensing waveforms to increase accuracy and efficient sensing and communications.

At 1102, the UE operates in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. As an example, the operating may be performed, at least in part, by the component 198. FIGS. 7, 8, 9 illustrate an example of the UE 802 operating in such a manner.

The UE 802 may be configured to operate (at 806) in one of a wireless communications mode or a sensing mode. The wireless communications mode may be associated with at least one of a communications waveform or a sensing waveform, and the sensing mode may be associated with at least one of the communications waveform or the sensing waveform (where the sensing waveform is different from the communications waveform, in aspects). For instance, the UE 802 may be configured to operate (at 806) in a wireless communications mode to communicate with a network node, e.g., the base station 804, via OFDM waveforms. The OFDM waveforms may be cyclic prefix (CP) OFDM (CP-OFDM) waveforms, DFT-s-OFDM waveforms, and/or the like, in aspects, and CP-OFDM waveforms may include a time gap subsequent to CP portions thereof. Additionally, the UE 802 may be configured to operate (at 806) in a sensing mode to sense targets (e.g., 906 in FIG. 9), with (e.g., bistatic sensing) or without (e.g., monostatic sensing) a network node (e.g., the base station 804), via analog RADAR waveforms (e.g., 702, 704, 706 in FIG. 7), as described herein (e.g., Linear FMCW waveforms, CW LMF waveforms, short CW waveforms, long CW waveforms (e.g., 702, 704, 706 in FIG. 7), and/or the like). Further the UE 802 may be configured to operate (at 806) in a wireless communications mode with sensing waveforms and/or in a sensing mode with communications waveforms, in some aspects.

At 1104, the UE obtains an indication of a switch to operate in another of the wireless communications mode or the sensing mode. As an example, the obtaining may be performed, at least in part, by the component 198. FIGS. 7, 8, 9 illustrate an example of the UE 802 obtaining an indication of a switch for modes of operation.

The UE 802 may be configured to obtain (at 808) an indication (e.g., at 808 in FIG. 8; 915 in FIG. 9) of a switch to operate in another of the wireless communications mode or the sensing mode. For instance, in one configuration, the UE 802 may autonomously and/or via user input reach a determination (e.g., obtain at 808) to switch its mode of operation between communications and sensing, in some aspects. In other aspects, the UE 802 may be configured to receive (e.g., obtain at 808) the indication (e.g., at 808 in FIG. 8; 915 in FIG. 9) from the base station 804 via signaling such as RRC signaling, a medium access control (MAC) control element (MAC-CE), DCI, etc. In aspects, the indication (e.g., at 808 in FIG. 8; 915 in FIG. 9) of the switch that is obtained (at 808) may be to switch from the wireless communications mode to the sensing mode, and the indication (e.g., at 808 in FIG. 8; 915 in FIG. 9) may include, without limitation, a channel associated with the switch, a sensing waveform type, sensing waveform type parameters, a usage for subsequent transmissions associated with the sensing waveform, and/or the like.

The UE 802 may be configured to obtain adaptation information that may be based on adaptation factors (e.g., 916 in FIG. 9). The UE 802 may autonomously (e.g., dynamically) and/or via user input obtain adaptation information and/or may be configured to receive adaptation information from the base station 804 via signaling such as RRC signaling, a medium access control (MAC) control element (MAC-CE), DCI, etc., which may be dynamically performed, in aspects. For instance, the UE 802 may be configured to obtain adaptation information based on an adaptation factor(s) (e.g., 916 in FIG. 9) that is associated with one or more of the sensing environment of the UE 802 (e.g., 930 in FIG. 9), sensing target (e.g., 906 in FIG. 9) characteristics, a hardware capability of the UE 802, a power budget of the UE 802, a transmission power capability of the UE 802, a maximum power emission/adjacent channel leakage ratio (ACLR) for the UE 802, and/or the like. In aspects, the UE 802 may obtain/receive at least a portion of the adaptation information based on adaptation factors (e.g., 916 in FIG. 9) from the base station 804 (e.g., a network node). In such aspects, the adaptation factor(s) (e.g., 916 in FIG. 9) may include, but are not limited to, a first distribution for target parameters, a static/dynamic range of the target parameters, clutter in the sensing environment, a power spectral density of the clutter (e.g., which may aid the waveform optimization to reduce the ambiguity area for lower interference impact), a second distribution or a static/dynamic range of a delay spread of the clutter, an activity of a RAT, and/or the like.

The UE 802 may be configured to select at communications and/or sensing waveforms (e.g., 918 in FIG. 9), which may be associated with a switch between communication/sensing modes. The selection may be for adaptation of waveforms (e.g., 918 in FIG. 9), and may be performed according to different scenarios and/or based on adaptation information associated with adaptation factors (e.g., 916 in FIG. 9). For instance, the UE 802 may be configured to select the sensing waveform (e.g., 918 in FIG. 9) based on an implementation (e.g., 920 in FIG. 9) of the UE 802, an operating condition (e.g., 920 in FIG. 9) of the UE 802, a sensing environment (e.g., 930 in FIG. 9) associated with the UE 802, and/or the like, in aspects. In some aspects, the UE 802 may be configured to select the sensing waveform (e.g., 918 in FIG. 9) as a CW LMF waveform (e.g., 702 in FIG. 7) based on a target Doppler that is less than, or less than or equal to, a Doppler threshold (e.g., 920 in FIG. 9). In some aspects, the UE 802 may be configured to select the sensing waveform as a long unmodulated CW waveform (e.g., 706 in FIG. 7) based on a target Doppler that is greater than, or greater than or equal to, a Doppler threshold, where the Doppler threshold (e.g., 920 in FIG. 9) may be associated with, and may be greater than, that of a CW LMF waveform (e.g., 702 in FIG. 7) and a short unmodulated CW waveform (e.g., 704 in FIG. 7).

In aspects, the UE 802 may be configured to select the sensing waveform (e.g., 918 in FIG. 9) as a short pulse waveform (e.g., 704 in FIG. 7) based on monostatic sensing (e.g., 920 in FIG. 9) being, or to be, performed at the UE 802. For instance, if the UE 802 does not support full duplex RF sensing (e.g., does not support bistatic sensing (e.g., 920 in FIG. 9), but supports monostatic sensing (e.g., 920 in FIG. 9)), a short pulse waveform, such as a short CW pulse waveform (e.g., 704 in FIG. 7), may be selected for sensing operations instead of a long CW pulse waveform (e.g., 706 in FIG. 7).

Additionally, the UE 802 may be configured to select the sensing waveform (e.g., 918 in FIG. 9) from one or more different bands (e.g., 920 in FIG. 9). In some aspects, the UE 802 may be configured to select the sensing waveform (e.g., 918 in FIG. 9), from one or more different bands based on a cost-performance ratio (e.g., 920 in FIG. 9), as a CW LMF waveform (e.g., 702 in FIG. 7) in a first band having a first bandwidth or as a pulse waveform (e.g., 704, 706 in FIG. 7) in a second band having a second bandwidth (e.g., where the first bandwidth is larger than the second bandwidth). As one example, in a high band with a large bandwidth, such as FR2, a linear FMCW waveform (e.g., 702 in FIG. 7) may be selected based on a high cost-performance ratio (e.g., 920 in FIG. 9). As another example, in a lower band with low to medium bandwidth, a pulse radar waveform (e.g., 704, 706 in FIG. 7) may be selected by reusing the hardware for communication operations.

In some aspects, the UE 802 may be configured to select the sensing waveform (e.g., 920 in FIG. 9) as a CW LMF waveform (e.g., 702 in FIG. 7) for an outdoor environment or as a pulse waveform (e.g., 704, 706 in FIG. 7) in an indoor environment (e.g., 932 in FIG. 9). As on example, for indoor use cases, the operation range may be small, and the signal power to be utilized may be much lower than outdoor use cases; therefore, a pulse radar waveform (e.g., 704, 706 in FIG. 7) may be considered and selected. For outdoor use cases, the operation range may be large, and the signal power for performance may be higher than indoor use cases; therefore; a linear FMCW waveform (e.g., 702 in FIG. 7) may be considered and selected. It should be noted that linear FMCW waveforms (e.g., 702 in FIG. 7) may transmit with long duration and maintain a high resolution, while pulse radar waveforms (e.g., 704, 706 in FIG. 7) may be transmitted with short durations to achieve high resolution, and this may result in a much higher peak power if used for long range sensing.

At 1106, the UE switches to the another of the wireless communications mode or the sensing mode based on the indication. As an example, the switch may be performed, at least in part, by the component 198. FIGS. 8, 9 illustrate an example of the UE 802 performing such a switch for modes of operation.

The UE 802 may be configured to switch (at 810) to the another of the wireless communications mode or the sensing mode based on the indication (e.g., at 808 in FIG. 8; 915 in FIG. 9). For instance, the UE 802 may be configured to switch (at 810) from the wireless communications mode (operated in at 806) to the sensing mode based on the indication (e.g., at 808 in FIG. 8; 915 in FIG. 9), and the UE 802 may be configured to switch (at 810) from the sensing mode (operated in at 806) to the wireless communications mode based on the indication (e.g., at 808 in FIG. 8; 915 in FIG. 9). In aspects, the UE 802 may be configured to switch (at 810) subsequent to a time gap, where the time gap is associated with, and in addition to, a CP duration and is associated with transmission switching and/or reception switching (e.g., at 810). For instance, the UE 802 and/or the base station 804 may not be expected to perform, or be capable of, processing/receiving the switched-to waveform during the switching gap (e.g., for Tx switching and/or Rx switching). In other aspects, the UE 802 may be configured to switch (at 810) during the CP duration and without the time gap. For instance, the UE 802 and/or the base station 804 may be expected to perform, or be capable of, processing/receiving the switched-to waveform during or within the CP duration, e.g., of CP-OFDM or DFT-s-OFDM waveforms (e.g., 918 in FIG. 9). In such cases, the gap may not be included. As one example, if the waveform switches from an RF sensing mode to a communications mode, the OFDM symbol after the CP may be acceptably impacted in terms of communication performance, and/or the impacted OFDM symbol may be specially treated in the signal processing. Likewise, for such cases, the impact for RF sensing may be acceptable with respect to accuracy, performance, and/or the like.

Finally, the UE 802 may be configured to transmit or provide, e.g., to the base station 804, waveform switch information 812. The waveform switch information 812 may be associated with any information related to the switch (at 810), and may indicate and/or include at least a portion of the information described above for switched waveforms, channels, waveform types and/or parameters, subsequent transmissions, waveform adaptation, and/or the like, in aspects. In some aspects, the waveform switch information 812 may be transmitted/provided from the UE 802 to the base station 804 as a response or acknowledgement to receiving/obtaining (at 808) the indication of the switch to operate in another of the wireless communications mode or the sensing mode, while in other aspects the waveform switch information 812 may be transmitted/provided as informational.

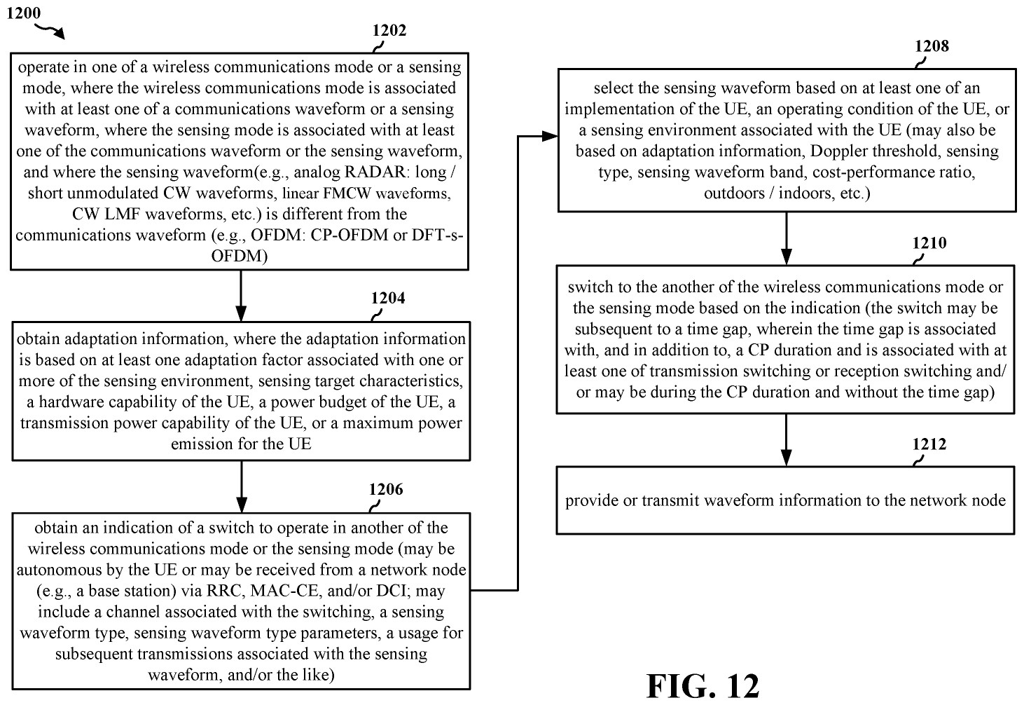

FIG. 12 is a flowchart 1200 of a method of wireless communication, in various aspects. The method may be performed by a UE (e.g., the UE 104, 404, 802, 902. 1002; the apparatus 1504). In some aspects, the method may include aspects described in connection with the communication flow in FIG. 8 and/or aspects described in FIGS. 4-7 and 9. The method provides for waveform adaptations in RF sensing that enables a UE to switch between communication and sensing modes of operation to provide more accurate and efficient sensing data for targets through analog RADAR waveforms, including, but without limitation, linear FMCW waveforms, and also to provide improved spectral efficiency over other waveforms by utilizing OFDM wave forms for communications, as well as additional adaptations for communication and sensing waveforms to increase accuracy and efficient sensing and communications.

At 1202, the UE operates in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. As an example, the operating may be performed, at least in part, by the component 198. FIGS. 7, 8, 9 illustrate an example of the UE 802 operating in such a manner.

The UE 802 may be configured to operate (at 806) in one of a wireless communications mode or a sensing mode. The wireless communications mode may be associated with at least one of a communications waveform or a sensing waveform, and the sensing mode may be associated with at least one of the communications waveform or the sensing waveform (where the sensing waveform is different from the communications waveform, in aspects). For instance, the UE 802 may be configured to operate (at 806) in a wireless communications mode to communicate with a network node, e.g., the base station 804, via OFDM waveforms. The OFDM waveforms may be cyclic prefix (CP) OFDM (CP-OFDM) waveforms, DFT-s-OFDM waveforms, and/or the like, in aspects, and CP-OFDM waveforms may include a time gap subsequent to CP portions thereof. Additionally, the UE 802 may be configured to operate (at 806) in a sensing mode to sense targets (e.g., 906 in FIG. 9), with (e.g., bistatic sensing) or without (e.g., monostatic sensing) a network node (e.g., the base station 804), via analog RADAR waveforms (e.g., 702, 704, 706 in FIG. 7), as described herein (e.g., Linear FMCW waveforms, CW LMF waveforms, short CW waveforms, long CW waveforms (e.g., 702, 704, 706 in FIG. 7), and/or the like). Further the UE 802 may be configured to operate (at 806) in a wireless communications mode with sensing waveforms and/or in a sensing mode with communications waveforms, in some aspects.

At 1204, the UE obtains adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE. As an example, the obtaining may be performed, at least in part, by the component 198. FIGS. 7, 8, 9 illustrate an example of the UE 802 obtaining such adaptation information.

The UE 802 may be configured to obtain adaptation information that may be based on adaptation factors (e.g., 916 in FIG. 9). The UE 802 may autonomously (e.g., dynamically) and/or via user input obtain adaptation information and/or may be configured to receive adaptation information from the base station 804 via signaling such as RRC signaling, a medium access control (MAC) control element (MAC-CE), DCI, etc., which may be dynamically performed, in aspects. For instance, the UE 802 may be configured to obtain adaptation information based on an adaptation factor(s) (e.g., 916 in FIG. 9) that is associated with one or more of the sensing environment of the UE 802 (e.g., 930 in FIG. 9), sensing target (e.g., 906 in FIG. 9) characteristics, a hardware capability of the UE 802, a power budget of the UE 802, a transmission power capability of the UE 802, a maximum power emission/adjacent channel leakage ratio (ACLR) for the UE 802, and/or the like. In aspects, the UE 802 may obtain/receive at least a portion of the adaptation information based on adaptation factors (e.g., 916 in FIG. 9) from the base station 804 (e.g., a network node). In such aspects, the adaptation factor(s) (e.g., 916 in FIG. 9) may include, but are not limited to, a first distribution for target parameters, a static/dynamic range of the target parameters, clutter in the sensing environment, a power spectral density of the clutter (e.g., which may aid the waveform optimization to reduce the ambiguity area for lower interference impact), a second distribution or a static/dynamic range of a delay spread of the clutter, an activity of a RAT, and/or the like.

At 1206, the UE obtains an indication of a switch to operate in another of the wireless communications mode or the sensing mode. As an example, the obtaining may be performed, at least in part, by the component 198. FIGS. 7, 8, 9 illustrate an example of the UE 802 obtaining an indication of a switch for modes of operation.

The UE 802 may be configured to obtain (at 808) an indication (e.g., at 808 in FIG. 8; 915 in FIG. 9) of a switch to operate in another of the wireless communications mode or the sensing mode. For instance, in one configuration, the UE 802 may autonomously and/or via user input reach a determination (e.g., obtain at 808) to switch its mode of operation between communications and sensing, in some aspects. In other aspects, the UE 802 may be configured to receive (e.g., obtain at 808) the indication (e.g., at 808 in FIG. 8; 915 in FIG. 9) from the base station 804 via signaling such as RRC signaling, a medium access control (MAC) control element (MAC-CE), DCI, etc. In aspects, the indication (e.g., at 808 in FIG. 8; 915 in FIG. 9) of the switch that is obtained (at 808) may be to switch from the wireless communications mode to the sensing mode, and the indication (e.g., at 808 in FIG. 8; 915 in FIG. 9) may include, without limitation, a channel associated with the switch, a sensing waveform type, sensing waveform type parameters, a usage for subsequent transmissions associated with the sensing waveform, and/or the like.

At 1208, the UE select the sensing waveform based on at least one of an implementation of the UE, an operating condition of the UE, or a sensing environment associated with the UE. As an example, the selection may be performed, at least in part, by the component 198. FIGS. 7, 8, 9 illustrate an example of the UE 802 selecting such a sensing waveform.

The UE 802 may be configured to select at communications and/or sensing waveforms (e.g., 918 in FIG. 9), which may be associated with a switch between communication/sensing modes. The selection may be for adaptation of waveforms (e.g., 918 in FIG. 9), and may be performed according to different scenarios and/or based on adaptation information associated with adaptation factors (e.g., 916 in FIG. 9). For instance, the UE 802 may be configured to select the sensing waveform (e.g., 918 in FIG. 9) based on an implementation (e.g., 920 in FIG. 9) of the UE 802, an operating condition (e.g., 920 in FIG. 9) of the UE 802, a sensing environment (e.g., 930 in FIG. 9) associated with the UE 802, and/or the like, in aspects. In some aspects, the UE 802 may be configured to select the sensing waveform (e.g., 918 in FIG. 9) as a CW LMF waveform (e.g., 702 in FIG. 7) based on a target Doppler that is less than, or less than or equal to, a Doppler threshold (e.g., 920 in FIG. 9). In some aspects, the UE 802 may be configured to select the sensing waveform as a long unmodulated CW waveform (e.g., 706 in FIG. 7) based on a target Doppler that is greater than, or greater than or equal to, a Doppler threshold, where the Doppler threshold (e.g., 920 in FIG. 9) may be associated with, and may be greater than, that of a CW LMF waveform (e.g., 702 in FIG. 7) and a short unmodulated CW waveform (e.g., 704 in FIG. 7).

In aspects, the UE 802 may be configured to select the sensing waveform (e.g., 918 in FIG. 9) as a short pulse waveform (e.g., 704 in FIG. 7) based on monostatic sensing (e.g., 920 in FIG. 9) being, or to be, performed at the UE 802. For instance, if the UE 802 does not support full duplex RF sensing (e.g., does not support bistatic sensing (e.g., 920 in FIG. 9), but supports monostatic sensing (e.g., 920 in FIG. 9)), a short pulse waveform, such as a short CW pulse waveform (e.g., 704 in FIG. 7), may be selected for sensing operations instead of a long CW pulse waveform (e.g., 706 in FIG. 7).

Additionally, the UE 802 may be configured to select the sensing waveform (e.g., 918 in FIG. 9) from one or more different bands (e.g., 920 in FIG. 9). In some aspects, the UE 802 may be configured to select the sensing waveform (e.g., 918 in FIG. 9), from one or more different bands based on a cost-performance ratio (e.g., 920 in FIG. 9), as a CW LMF waveform (e.g., 702 in FIG. 7) in a first band having a first bandwidth or as a pulse waveform (e.g., 704, 706 in FIG. 7) in a second band having a second bandwidth (e.g., where the first bandwidth is larger than the second bandwidth). As one example, in a high band with a large bandwidth, such as FR2, a linear FMCW waveform (e.g., 702 in FIG. 7) may be selected based on a high cost-performance ratio (e.g., 920 in FIG. 9). As another example, in a lower band with low to medium bandwidth, a pulse radar waveform (e.g., 704, 706 in FIG. 7) may be selected by reusing the hardware for communication operations.

In some aspects, the UE 802 may be configured to select the sensing waveform (e.g., 920 in FIG. 9) as a CW LMF waveform (e.g., 702 in FIG. 7) for an outdoor environment or as a pulse waveform (e.g., 704, 706 in FIG. 7) in an indoor environment (e.g., 932 in FIG. 9). As on example, for indoor use cases, the operation range may be small, and the signal power to be utilized may be much lower than outdoor use cases; therefore, a pulse radar waveform (e.g., 704, 706 in FIG. 7) may be considered and selected. For outdoor use cases, the operation range may be large, and the signal power for performance may be higher than indoor use cases; therefore; a linear FMCW waveform (e.g., 702 in FIG. 7) may be considered and selected. It should be noted that linear FMCW waveforms (e.g., 702 in FIG. 7) may transmit with long duration and maintain a high resolution, while pulse radar waveforms (e.g., 704, 706 in FIG. 7) may be transmitted with short durations to achieve high resolution, and this may result in a much higher peak power if used for long range sensing.

At 1210, the UE switches to the another of the wireless communications mode or the sensing mode based on the indication. As an example, the switch may be performed, at least in part, by the component 198. FIGS. 8, 9 illustrate an example of the UE 802 performing such a switch for modes of operation.

The UE 802 may be configured to switch (at 810) to the another of the wireless communications mode or the sensing mode based on the indication (e.g., at 808 in FIG. 8; 915 in FIG. 9). For instance, the UE 802 may be configured to switch (at 810) from the wireless communications mode (operated in at 806) to the sensing mode based on the indication (e.g., at 808 in FIG. 8; 915 in FIG. 9), and the UE 802 may be configured to switch (at 810) from the sensing mode (operated in at 806) to the wireless communications mode based on the indication (e.g., at 808 in FIG. 8; 915 in FIG. 9). In aspects, the UE 802 may be configured to switch (at 810) subsequent to a time gap, where the time gap is associated with, and in addition to, a CP duration and is associated with transmission switching and/or reception switching (e.g., at 810). For instance, the UE 802 and/or the base station 804 may not be expected to perform, or be capable of, processing/receiving the switched-to waveform during the switching gap (e.g., for Tx switching and/or Rx switching). In other aspects, the UE 802 may be configured to switch (at 810) during the CP duration and without the time gap. For instance, the UE 802 and/or the base station 804 may be expected to perform, or be capable of, processing/receiving the switched-to waveform during or within the CP duration, e.g., of CP-OFDM or DFT-s-OFDM waveforms (e.g., 918 in FIG. 9). In such cases, the gap may not be included. As one example, if the waveform switches from an RF sensing mode to a communications mode, the OFDM symbol after the CP may be acceptably impacted in terms of communication performance, and/or the impacted OFDM symbol may be specially treated in the signal processing. Likewise, for such cases, the impact for RF sensing may be acceptable with respect to accuracy, performance, and/or the like.

Finally, at 1212, the UE provides or transmits waveform information to the network node. As an example, the switch may be performed, at least in part, by the component 198. FIG. 8 illustrate an example of the UE 802 performing such provision/transmission for waveform information.

The UE 802 may be configured to transmit or provide, e.g., to the base station 804. waveform switch information 812. The waveform switch information 812 may be associated with any information related to the switch (at 810), and may indicate and/or include at least a portion of the information described above for switched waveforms, channels, waveform types and/or parameters, subsequent transmissions, waveform adaptation, and/or the like, in aspects. In some aspects, the waveform switch information 812 may be transmitted/provided from the UE 802 to the base station 804 as a response or acknowledgement to receiving/obtaining (at 808) the indication of the switch to operate in another of the wireless communications mode or the sensing mode, while in other aspects the waveform switch information 812 may be transmitted/provided as informational.

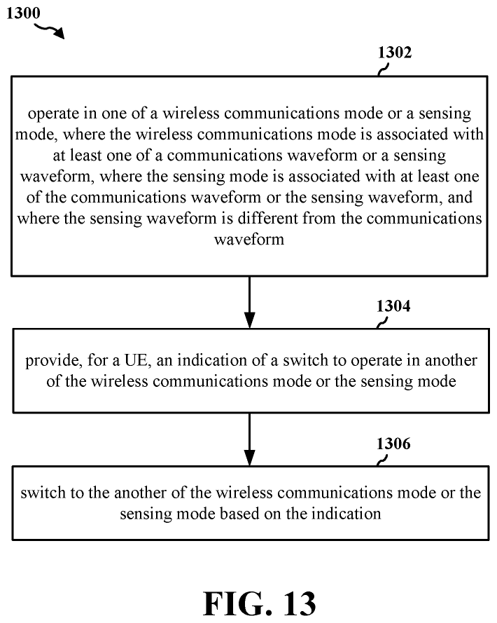

FIG. 13 is a flowchart 1300 of a method of wireless communication, in various aspects. The method may be performed by a base station (e.g., the base station 102. 804. 922, 1004; the network entity 1502, 1602). In some aspects, the method may include aspects described in connection with the communication flow in FIG. 8 and/or aspects described in FIGS. 4-7 and 9. The method provides for waveform adaptations in RF sensing that enables a base station provide indications for a switch and to switch between communication and sensing modes of operation to provide more accurate and efficient sensing data for targets through analog RADAR waveforms, including, but without limitation, linear FMCW waveforms, and also to provide improved spectral efficiency over other waveforms by utilizing OFDM wave forms for communications, as well as additional adaptations for communication and sensing waveforms to increase accuracy and efficient sensing and communications.

At 1302, the base station operates in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. As an example, the operating may be performed, at least in part, by the component 199. FIGS. 7, 9, 10 illustrate an example of the base station 1004 operating in such a manner.

The base station 1004 may be configured to operate (at 1006) in one of a wireless communications mode or a sensing mode. The wireless communications mode may be associated with at least one of a communications waveform or a sensing waveform, and the sensing mode may be associated with at least one of the communications waveform or the sensing waveform (where the sensing waveform is different from the communications waveform, in aspects). For instance, the base station 1004 may be configured to operate (at 1006) in a wireless communications mode to communicate with a network node, e.g., the base station 804, via OFDM waveforms. The OFDM waveforms may be cyclic prefix (CP) OFDM (CP-OFDM) waveforms, DFT-s-OFDM waveforms, and/or the like, in aspects, and CP-OFDM waveforms may include a time gap subsequent to CP portions thereof. Additionally, the UE 802 may be configured to operate (at 1006) in a sensing mode to sense targets (e.g., 906 in FIG. 9), with (e.g., bistatic sensing) or without (e.g., monostatic sensing) a UE (e.g., the UE 1002), via analog RADAR waveforms (e.g., 702, 704, 706 in FIG. 7), as described herein (e.g., Linear FMCW waveforms, CW LMF waveforms, short CW waveforms, long CW waveforms (e.g., 702, 704, 706 in FIG. 7), and/or the like). Further the base station 1004 may be configured to operate (at 1006) in a wireless communications mode with sensing waveforms and/or in a sensing mode with communications waveforms, in some aspects.

At 1304, the base station provides, for a UE, an indication of a switch to operate in another of the wireless communications mode or the sensing mode. As an example, the provision may be performed, at least in part, by the component 199. FIGS. 7, 9, 10 illustrate an example of the base station 1004 obtaining an indication of a switch for modes of operation.

The base station 1004 may be configured to provide an indication 1008 (e.g., 915 in FIG. 9) of a switch to operate in another of the wireless communications mode or the sensing mode. For instance, in one configuration, the base station 1004 may autonomously reach a determination to switch its mode of operation between communications and sensing, in some aspects, and may be configured to provide/transmit the indication 1008 (e.g., 915 in FIG. 9) for the UE 1002 via signaling such as RRC signaling, a medium access control (MAC) control element (MAC-CE), DCI, etc. In aspects, the indication 1008 (e.g., 915 in FIG. 9) of the switch that is provided/transmitted may be to switch from the wireless communications mode to the sensing mode, and the indication 1008 (e.g., 915 in FIG. 9) may include, without limitation, a channel associated with the switch, a sensing waveform type, sensing waveform type parameters, a usage for subsequent transmissions associated with the sensing waveform, and/or the like.

The base station 1004 may be configured to obtain adaptation information that may be based on adaptation factors (e.g., 916 in FIG. 9). The base station 1004 may autonomously (e.g., dynamically) obtain adaptation information and/or may be configured to provide the adaptation information for the UE 1002 via signaling such as RRC signaling, a medium access control (MAC) control element (MAC-CE), DCI, etc., which may be dynamically performed, in aspects. For instance, the base station 1004 may be configured to provide/transmit the adaptation information based on an adaptation factor(s) (e.g., 916 in FIG. 9) that is associated with one or more of the sensing environment of the UE 1002 (e.g., 930 in FIG. 9), sensing target (e.g., 906 in FIG. 9) characteristics, a hardware capability of the UE 1002, a power budget of the UE 1002, a transmission power capability of the UE 1002, a maximum power emission/adjacent channel leakage ratio (ACLR) for the UE 1002, a first distribution for target parameters, a static/dynamic range of the target parameters, clutter in the sensing environment, a power spectral density of the clutter (e.g., which may aid the waveform optimization to reduce the ambiguity area for lower interference impact), a second distribution or a static/dynamic range of a delay spread of the clutter, an activity of a RAT, and/or the like.

The base station 1004 may be configured to select at communications and/or sensing waveforms (e.g., 918 in FIG. 9), which may be associated with a switch between communication/sensing modes. The selection may be for adaptation of waveforms (e.g., 918 in FIG. 9), and may be performed according to different scenarios and/or based on adaptation information associated with adaptation factors (e.g., 916 in FIG. 9). For instance, the base station 1004 may be configured to select the sensing waveform (e.g., 918 in FIG. 9) based on an implementation (e.g., 920 in FIG. 9) of the UE 802, an operating condition (e.g., 920 in FIG. 9) of the UE 1002, a sensing environment (e.g., 930 in FIG. 9) associated with the UE 1002, and/or the like, in aspects. In some aspects, the base station 1004 may be configured to select the sensing waveform (e.g., 918 in FIG. 9) as a CW LMF waveform (e.g., 702 in FIG. 7) based on a target Doppler that is less than, or less than or equal to, a Doppler threshold (e.g., 920 in FIG. 9). In some aspects, the UE 1002 may be configured to select the sensing waveform as a long unmodulated CW waveform (e.g., 706 in FIG. 7) based on a target Doppler that is greater than, or greater than or equal to, a Doppler threshold, where the Doppler threshold (e.g., 920 in FIG. 9) may be associated with, and may be greater than, that of a CW LMF waveform (e.g., 702 in FIG. 7) and a short unmodulated CW waveform (e.g., 704 in FIG. 7).

In aspects, the base station 1004 may be configured to select the sensing waveform (e.g., 918 in FIG. 9) as a short pulse waveform (e.g., 704 in FIG. 7) based on monostatic sensing (e.g., 920 in FIG. 9) being, or to be, performed at the UE 1002. For instance, if the UE 1002 does not support full duplex RF sensing (e.g., does not support bistatic sensing (e.g., 920 in FIG. 9), but supports monostatic sensing (e.g., 920 in FIG. 9)), a short pulse waveform, such as a short CW pulse waveform (e.g., 704 in FIG. 7), may be selected for sensing operations instead of a long CW pulse waveform (e.g., 706 in FIG. 7).

Additionally, the base station 1004 may be configured to select the sensing waveform (e.g., 918 in FIG. 9) from one or more different bands (e.g., 920 in FIG. 9). In some aspects, the UE 1002 may be configured to select the sensing waveform (e.g., 918 in FIG. 9), from one or more different bands based on a cost-performance ratio (e.g., 920 in FIG. 9), as a CW LMF waveform (e.g., 702 in FIG. 7) in a first band having a first bandwidth or as a pulse waveform (e.g., 704, 706 in FIG. 7) in a second band having a second bandwidth (e.g., where the first bandwidth is larger than the second bandwidth). As one example, in a high band with a large bandwidth, such as FR2, a linear FMCW waveform (e.g., 702 in FIG. 7) may be selected based on a high cost-performance ratio (e.g., 920 in FIG. 9). As another example, in a lower band with low to medium bandwidth, a pulse radar waveform (e.g., 704, 706 in FIG. 7) may be selected by reusing the hardware for communication operations.

In some aspects, the base station 1004 may be configured to select the sensing waveform (e.g., 920 in FIG. 9) as a CW LMF waveform (e.g., 702 in FIG. 7) for an outdoor environment or as a pulse waveform (e.g., 704, 706 in FIG. 7) in an indoor environment (e.g., 932 in FIG. 9). As on example, for indoor use cases, the operation range may be small, and the signal power to be utilized may be much lower than outdoor use cases; therefore, a pulse radar waveform (e.g., 704, 706 in FIG. 7) may be considered and selected. For outdoor use cases, the operation range may be large, and the signal power for performance may be higher than indoor use cases; therefore; a linear FMCW waveform (e.g., 702 in FIG. 7) may be considered and selected. It should be noted that linear FMCW waveforms (e.g., 702 in FIG. 7) may transmit with long duration and maintain a high resolution, while pulse radar waveforms (e.g., 704, 706 in FIG. 7) may be transmitted with short durations to achieve high resolution, and this may result in a much higher peak power if used for long range sensing.

At 1306, the base station switches to the another of the wireless communications mode or the sensing mode based on the indication. As an example, the switch may be performed, at least in part, by the component 199. FIGS. 8, 9 illustrate an example of the base station 1004 performing such a switch for modes of operation.

The base station 1004 may be configured to switch (at 1010) to the another of the wireless communications mode or the sensing mode based on the indication 1008 (e.g., 915 in FIG. 9) of the switch. For instance, the base station 1004 may be configured to switch (at 1010) from the wireless communications mode (operated in at 1006) to the sensing mode based on the indication 1008 (e.g., 915 in FIG. 9) of the switch, and the base station 1004 may be configured to switch (at 1010) from the sensing mode (operated in at 1006) to the wireless communications mode based on the indication 1008 (e.g., 915 in FIG. 9). In aspects, the base station 1004 may be configured to switch (at 1010) subsequent to a time gap, where the time gap is associated with, and in addition to, a CP duration and is associated with transmission switching and/or reception switching (e.g., at 1010). For instance, the UE 1002 and/or the base station 1004 may not be expected to perform, or be capable of, processing/receiving the switched-to waveform during the switching gap (e.g., for Tx switching and/or Rx switching). In other aspects, the base station 1004 may be configured to switch (at 1010) during the CP duration and without the time gap. For instance, the UE 802 and/or the base station 804 may be expected to perform, or be capable of, processing/receiving the switched-to waveform during or within the CP duration, e.g., of CP-OFDM or DFT-s-OFDM waveforms (e.g., 918 in FIG. 9). In such cases, the gap may not be included. As one example, if the waveform switches from an RF sensing mode to a communications mode, the OFDM symbol after the CP may be acceptably impacted in terms of communication performance, and/or the impacted OFDM symbol may be specially treated in the signal processing. Likewise, for such cases, the impact for RF sensing may be acceptable with respect to accuracy, performance, and/or the like.

Finally, the base station 1004 may be configured to transmit or provide, e.g., to the UE 1002, waveform switch information 1012. The waveform switch information 1012 may be associated with any information related to the switch (at 1010), and may indicate and/or include at least a portion of the information described above for switched waveforms, channels, waveform types and/or parameters, subsequent transmissions, waveform adaptation, and/or the like, in aspects. In some aspects, the waveform switch information 1012 may be transmitted/provided for the UE 1002 from the base station 1004 as a confirmation of the indication 1008 of the switch to operate in another of the wireless communications mode or the sensing mode, or of the switch (at 1010) itself, while in other aspects the waveform switch information 1012 may be transmitted/provided as informational.

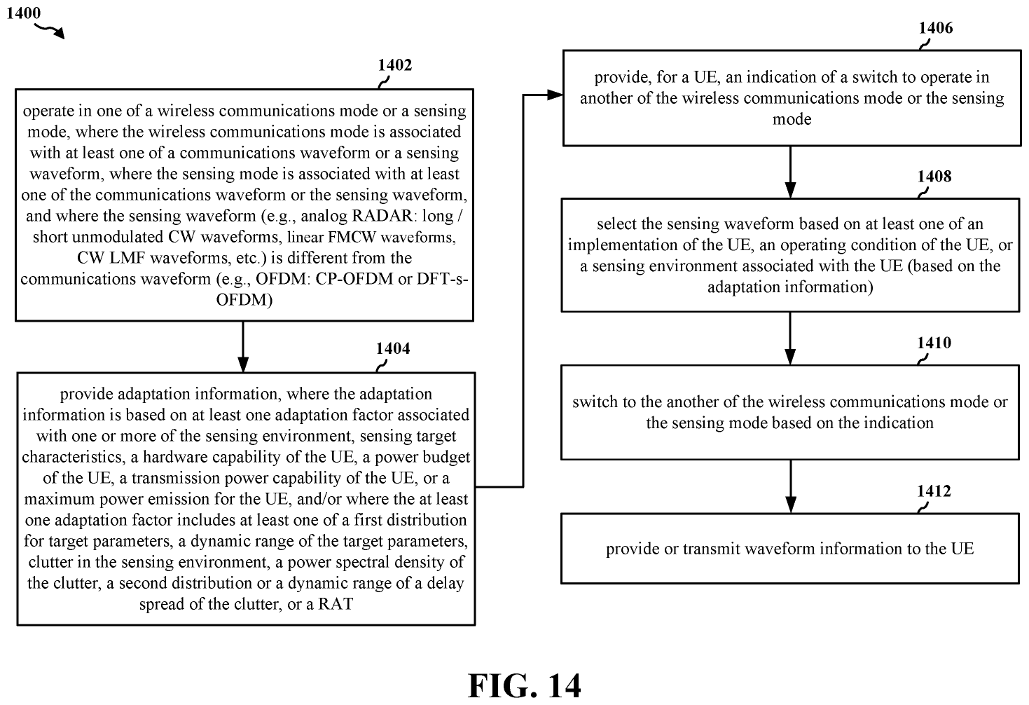

FIG. 14 is a flowchart 1400 of a method of wireless communication, in accordance with various aspects of the present disclosure. The method may be performed by a base station (e.g., the base station 102, 804, 922, 1004; the network entity 1502, 1602). In some aspects, the method may include aspects described in connection with the communication flow in FIG. 8 and/or aspects described in FIGS. 4-7 and 9. The method provides for waveform adaptations in RF sensing that enables a base station provide indications for a switch and to switch between communication and sensing modes of operation to provide more accurate and efficient sensing data for targets through analog RADAR waveforms, including, but without limitation, linear FMCW waveforms, and also to provide improved spectral efficiency over other waveforms by utilizing OFDM wave forms for communications, as well as additional adaptations for communication and sensing waveforms to increase accuracy and efficient sensing and communications.

At 1402, the base station operates in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. As an example, the operating may be performed, at least in part, by the component 199. FIGS. 7, 9, 10 illustrate an example of the base station 1004 operating in such a manner.

The base station 1004 may be configured to operate (at 1006) in one of a wireless communications mode or a sensing mode. The wireless communications mode may be associated with at least one of a communications waveform or a sensing waveform. and the sensing mode may be associated with at least one of the communications waveform or the sensing waveform (where the sensing waveform is different from the communications waveform, in aspects). For instance, the base station 1004 may be configured to operate (at 1006) in a wireless communications mode to communicate with a network node, e.g., the base station 804, via OFDM waveforms. The OFDM waveforms may be cyclic prefix (CP) OFDM (CP-OFDM) waveforms, DFT-s-OFDM waveforms, and/or the like, in aspects, and CP-OFDM waveforms may include a time gap subsequent to CP portions thereof. Additionally, the UE 802 may be configured to operate (at 1006) in a sensing mode to sense targets (e.g., 906 in FIG. 9), with (e.g., bistatic sensing) or without (e.g., monostatic sensing) a UE (e.g., the UE 1002), via analog RADAR waveforms (e.g., 702, 704, 706 in FIG. 7), as described herein (e.g., Linear FMCW waveforms, CW LMF waveforms, short CW waveforms, long CW waveforms (e.g., 702, 704, 706 in FIG. 7), and/or the like). Further the base station 1004 may be configured to operate (at 1006) in a wireless communications mode with sensing waveforms and/or in a sensing mode with communications waveforms, in some aspects.

At 1404, the base station provides, for a UE, adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and/or where the at least one adaptation factor includes at least one of a first distribution for target parameters, a dynamic range of the target parameters, clutter in the sensing environment, a power spectral density of the clutter, a second distribution or a dynamic range of a delay spread of the clutter, or a RAT. As an example, the provision may be performed, at least in part, by the component 199. FIGS. 7, 9, 10 illustrate an example of the base station 1004 providing such adaptation information.

The base station 1004 may be configured to obtain adaptation information that may be based on adaptation factors (e.g., 916 in FIG. 9). The base station 1004 may autonomously (e.g., dynamically) obtain adaptation information and/or may be configured to provide the adaptation information for the UE 1002 via signaling such as RRC signaling, a medium access control (MAC) control element (MAC-CE), DCI, etc., which may be dynamically performed, in aspects. For instance, the base station 1004 may be configured to provide/transmit the adaptation information based on an adaptation factor(s) (e.g., 916 in FIG. 9) that is associated with one or more of the sensing environment of the UE 1002 (e.g., 930 in FIG. 9), sensing target (e.g., 906 in FIG. 9) characteristics, a hardware capability of the UE 1002, a power budget of the UE 1002, a transmission power capability of the UE 1002, a maximum power emission/adjacent channel leakage ratio (ACLR) for the UE 1002, a first distribution for target parameters, a static/dynamic range of the target parameters, clutter in the sensing environment, a power spectral density of the clutter (e.g., which may aid the waveform optimization to reduce the ambiguity area for lower interference impact), a second distribution or a static/dynamic range of a delay spread of the clutter, an activity of a RAT, and/or the like.

At 1406, the base station provides, for a UE, an indication of a switch to operate in another of the wireless communications mode or the sensing mode. As an example, the provision may be performed, at least in part, by the component 199. FIGS. 7, 9, 10 illustrate an example of the base station 1004 providing an indication of a switch for modes of operation.

The base station 1004 may be configured to provide an indication 1008 (e.g., 915 in FIG. 9) of a switch to operate in another of the wireless communications mode or the sensing mode. For instance, in one configuration, the base station 1004 may autonomously reach a determination to switch its mode of operation between communications and sensing, in some aspects, and may be configured to provide/transmit the indication 1008 (e.g., 915 in FIG. 9) for the UE 1002 via signaling such as RRC signaling, a medium access control (MAC) control element (MAC-CE), DCI, etc. In aspects, the indication 1008 (e.g., 915 in FIG. 9) of the switch that is provided/transmitted may be to switch from the wireless communications mode to the sensing mode, and the indication 1008 (e.g., 915 in FIG. 9) may include, without limitation, a channel associated with the switch, a sensing waveform type, sensing waveform type parameters, a usage for subsequent transmissions associated with the sensing waveform, and/or the like.

At 1408, the base station selects the sensing waveform based on at least one of an implementation of the UE, an operating condition of the UE, or a sensing environment associated with the UE. As an example, the selection may be performed, at least in part, by the component 199. FIGS. 7, 9, 10 illustrate an example of the base station 1004 performing a selection of a such waveform.

The base station 1004 may be configured to select at communications and/or sensing waveforms (e.g., 918 in FIG. 9), which may be associated with a switch between communication/sensing modes. The selection may be for adaptation of waveforms (e.g., 918 in FIG. 9), and may be performed according to different scenarios and/or based on adaptation information associated with adaptation factors (e.g., 916 in FIG. 9). For instance, the base station 1004 may be configured to select the sensing waveform (e.g., 918 in FIG. 9) based on an implementation (e.g., 920 in FIG. 9) of the UE 802, an operating condition (e.g., 920 in FIG. 9) of the UE 1002, a sensing environment (e.g., 930 in FIG. 9) associated with the UE 1002, and/or the like, in aspects. In some aspects, the base station 1004 may be configured to select the sensing waveform (e.g., 918 in FIG. 9) as a CW LMF waveform (e.g., 702 in FIG. 7) based on a target Doppler that is less than, or less than or equal to, a Doppler threshold (e.g., 920 in FIG. 9). In some aspects, the UE 1002 may be configured to select the sensing waveform as a long unmodulated CW waveform (e.g., 706 in FIG. 7) based on a target Doppler that is greater than, or greater than or equal to, a Doppler threshold, where the Doppler threshold (e.g., 920 in FIG. 9) may be associated with, and may be greater than, that of a CW LMF waveform (e.g., 702 in FIG. 7) and a short unmodulated CW waveform (e.g., 704 in FIG. 7).

In aspects, the base station 1004 may be configured to select the sensing waveform (e.g., 918 in FIG. 9) as a short pulse waveform (e.g., 704 in FIG. 7) based on monostatic sensing (e.g., 920 in FIG. 9) being, or to be, performed at the UE 1002. For instance, if the UE 1002 does not support full duplex RF sensing (e.g., does not support bistatic sensing (e.g., 920 in FIG. 9), but supports monostatic sensing (e.g., 920 in FIG. 9)), a short pulse waveform, such as a short CW pulse waveform (e.g., 704 in FIG. 7), may be selected for sensing operations instead of a long CW pulse waveform (e.g., 706 in FIG. 7).

Additionally, the base station 1004 may be configured to select the sensing waveform (e.g., 918 in FIG. 9) from one or more different bands (e.g., 920 in FIG. 9). In some aspects, the UE 1002 may be configured to select the sensing waveform (e.g., 918 in FIG. 9), from one or more different bands based on a cost-performance ratio (e.g., 920 in FIG. 9), as a CW LMF waveform (e.g., 702 in FIG. 7) in a first band having a first bandwidth or as a pulse waveform (e.g., 704, 706 in FIG. 7) in a second band having a second bandwidth (e.g., where the first bandwidth is larger than the second bandwidth). As one example, in a high band with a large bandwidth, such as FR2, a linear FMCW waveform (e.g., 702 in FIG. 7) may be selected based on a high cost-performance ratio (e.g., 920 in FIG. 9). As another example, in a lower band with low to medium bandwidth, a pulse radar waveform (e.g., 704, 706 in FIG. 7) may be selected by reusing the hardware for communication operations.

In some aspects, the base station 1004 may be configured to select the sensing waveform (e.g., 920 in FIG. 9) as a CW LMF waveform (e.g., 702 in FIG. 7) for an outdoor environment or as a pulse waveform (e.g., 704, 706 in FIG. 7) in an indoor environment (e.g., 932 in FIG. 9). As on example, for indoor use cases, the operation range may be small, and the signal power to be utilized may be much lower than outdoor use cases; therefore, a pulse radar waveform (e.g., 704, 706 in FIG. 7) may be considered and selected. For outdoor use cases, the operation range may be large, and the signal power for performance may be higher than indoor use cases; therefore; a linear FMCW waveform (e.g., 702 in FIG. 7) may be considered and selected. It should be noted that linear FMCW waveforms (e.g., 702 in FIG. 7) may transmit with long duration and maintain a high resolution, while pulse radar waveforms (e.g., 704, 706 in FIG. 7) may be transmitted with short durations to achieve high resolution, and this may result in a much higher peak power if used for long range sensing.

At 1410, the base station switches to the another of the wireless communications mode or the sensing mode based on the indication. As an example, the switch may be performed, at least in part, by the component 199. FIGS. 8, 9 illustrate an example of the base station 1004 performing such a switch for modes of operation.

The base station 1004 may be configured to switch (at 1010) to the another of the wireless communications mode or the sensing mode based on the indication 1008 (e.g., 915 in FIG. 9) of the switch. For instance, the base station 1004 may be configured to switch (at 1010) from the wireless communications mode (operated in at 1006) to the sensing mode based on the indication 1008 (e.g., 915 in FIG. 9) of the switch, and the base station 1004 may be configured to switch (at 1010) from the sensing mode (operated in at 1006) to the wireless communications mode based on the indication 1008 (e.g., 915 in FIG. 9). In aspects, the base station 1004 may be configured to switch (at 1010) subsequent to a time gap, where the time gap is associated with, and in addition to, a CP duration and is associated with transmission switching and/or reception switching (e.g., at 1010). For instance, the UE 1002 and/or the base station 1004 may not be expected to perform, or be capable of, processing/receiving the switched-to waveform during the switching gap (e.g., for Tx switching and/or Rx switching). In other aspects, the base station 1004 may be configured to switch (at 1010) during the CP duration and without the time gap. For instance, the UE 802 and/or the base station 804 may be expected to perform, or be capable of, processing/receiving the switched-to waveform during or within the CP duration, e.g., of CP-OFDM or DFT-s-OFDM waveforms (e.g., 918 in FIG. 9). In such cases, the gap may not be included. As one example, if the waveform switches from an RF sensing mode to a communications mode, the OFDM symbol after the CP may be acceptably impacted in terms of communication performance, and/or the impacted OFDM symbol may be specially treated in the signal processing. Likewise, for such cases, the impact for RF sensing may be acceptable with respect to accuracy, performance, and/or the like.

Finally, at 1412, the base station provides or transmits waveform information to a UE. As an example, the provision/transmission may be performed, at least in part, by the component 199. FIGS. 7, 9, 10 illustrate an example of the base station 1004 providing/transmitting such waveform information.

The base station 1004 may be configured to transmit or provide, e.g., to the UE 1002, waveform switch information 1012. The waveform switch information 1012 may be associated with any information related to the switch (at 1010), and may indicate and/or include at least a portion of the information described above for switched waveforms, channels, waveform types and/or parameters, subsequent transmissions, waveform adaptation, and/or the like, in aspects. In some aspects, the waveform switch information 1012 may be transmitted/provided for the UE 1002 from the base station 1004 as a confirmation of the indication 1008 of the switch to operate in another of the wireless communications mode or the sensing mode, or of the switch (at 1010) itself, while in other aspects the waveform switch information 1012 may be transmitted/provided as informational.

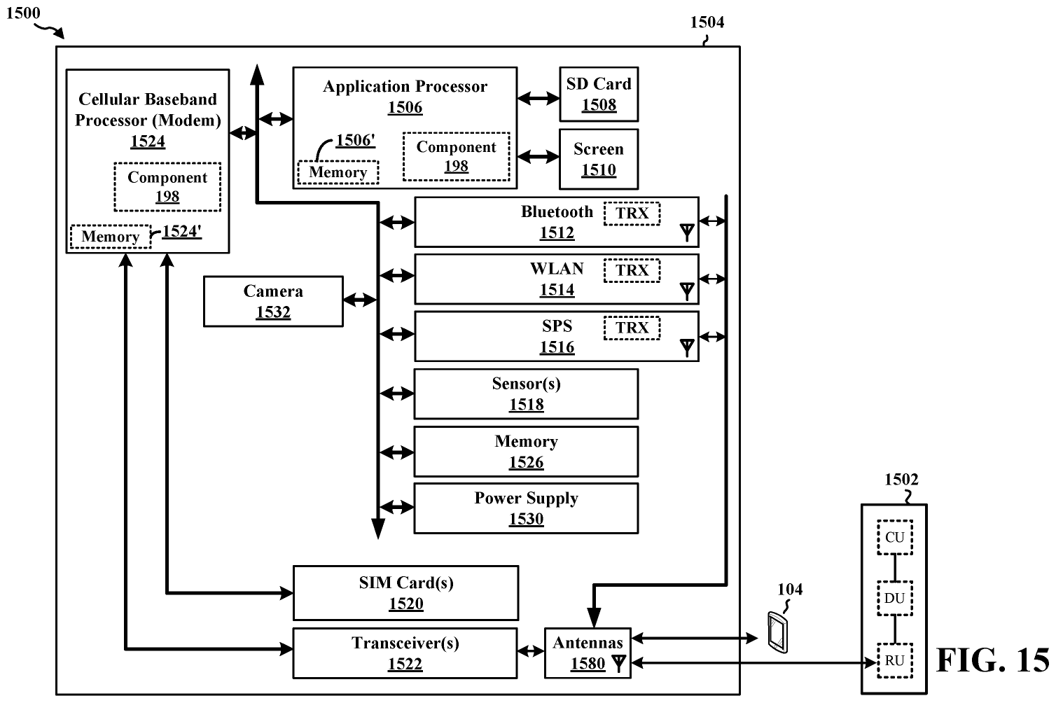

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., sec UE 350 of FIG. 3) and include the additional modules of the apparatus 1504.

As discussed supra, the component 198 may be configured to operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The component 198 may also be configured to obtain an indication of a switch to operate in another of the wireless communications mode or the sensing mode. The component 198 may be further configured to switch to the another of the wireless communications mode or the sensing mode based on the indication. The component 198 may be configured to select the sensing waveform based on at least one of an implementation of the UE, an operating condition of the UE, or a sensing environment associated with the UE. The component 198 may be configured to obtain adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and where to select the sensing waveform, the component 198 may be configured to select the sensing waveform based on the adaptation information. The component 198 may be further configured to perform any of the aspects described in connection with the flowcharts in any of FIGS. 11-14, and/or any of the aspects performed by the UE in any of FIGS. 5-10. The component 198 may be within the cellular baseband processor 1524, the application processor 1506, or both the cellular baseband processor 1524 and the application processor 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, may include means for operating in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. In the configuration, the apparatus 1504, and in particular the cellular baseband processor 1524 and/or the application processor 1506, may include means for obtaining an indication of a switch to operate in another of the wireless communications mode or the sensing mode. In the configuration, the apparatus 1504. and in particular the cellular baseband processor 1524 and/or the application processor 1506, may include means for switching to the another of the wireless communications mode or the sensing mode based on the indication. In one configuration, the apparatus 1504, and in particular the cellular baseband processor 1524 and/or the application processor 1506, may include means for selecting the sensing waveform based on at least one of an implementation of the UE, an operating condition of the UE, or a sensing environment associated with the UE. In one configuration, the apparatus 1504, and in particular the cellular baseband processor 1524 and/or the application processor 1506, may include means for obtaining adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and where the apparatus 1504, and in particular the cellular baseband processor 1524 and/or the application processor 1506, may include means for selecting the sensing waveform based on the adaptation information. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

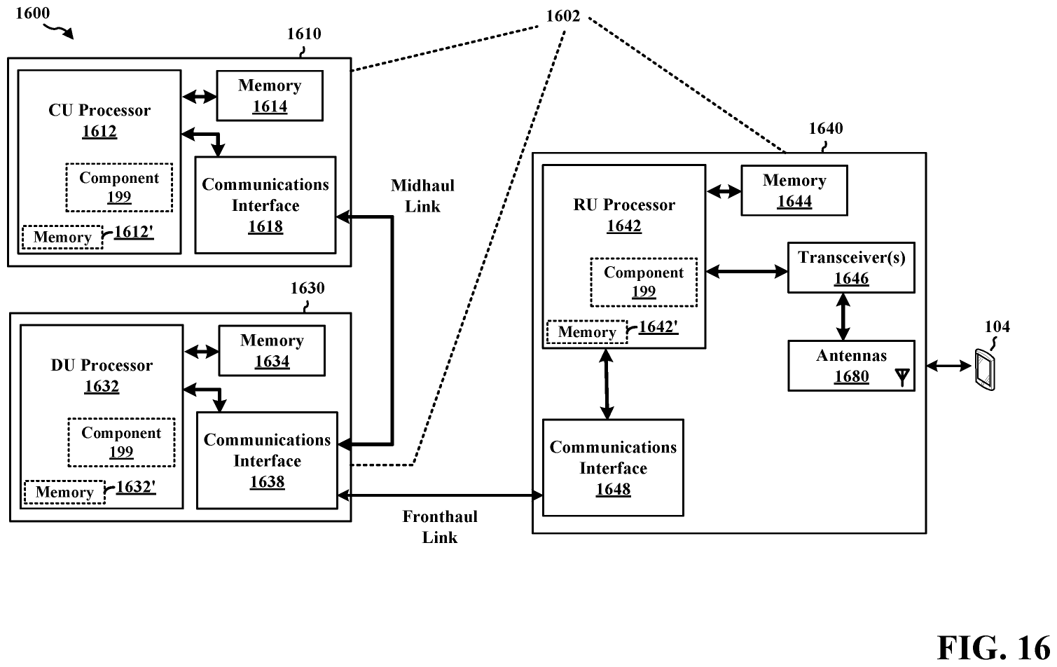

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The component 199 may also be configured to provide, for a UE, an indication of a switch to operate in another of the wireless communications mode or the sensing mode. The component 199 may be further configured to switch to the another of the wireless communications mode or the sensing mode based on the indication. The component 199 may be configured to select the sensing waveform based on at least one of an implementation of the UE, an operating condition of the UE, or a sensing environment associated with the UE. The component 199 may be configured to provide adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and where the at least one adaptation factor includes at least one of a first distribution for target parameters, a dynamic range of the target parameters, clutter in the sensing environment, a power spectral density of the clutter, a second distribution or a dynamic range of a delay spread of the clutter, or a radio access technology (RAT), and where to select the sensing waveform, the component 199 may be configured to select the sensing waveform based on the adaptation information. The component 199 may be further configured to perform any of the aspects described in connection with the flowcharts in any of FIGS. 11-14, and/or any of the aspects performed by the base station in any of FIGS. 5-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 may include means for operating in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. In the configuration, the network entity 1602 may include means for providing, for a UE, an indication of a switch to operate in another of the wireless communications mode or the sensing mode. In the configuration, the network entity 1602 may include means for switching to the another of the wireless communications mode or the sensing mode based on the indication. In one configuration, the network entity 1602 may include means for selecting the sensing waveform based on at least one of an implementation of the UE, an operating condition of the UE, or a sensing environment associated with the UE. In one configuration, the network entity 1602 may include means for providing adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and where the at least one adaptation factor includes at least one of a first distribution for target parameters, a dynamic range of the target parameters, clutter in the sensing environment, a power spectral density of the clutter, a second distribution or a dynamic range of a delay spread of the clutter, or a radio access technology (RAT), and where the network entity 1602 may include means for selecting the sensing waveform based on the adaptation information. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means. Wireless communication networks and/or wireless devices may utilize a specific waveform for communications and sensing. The use of such a waveform may provide for low cost, allow flexibility, and allow the re-use of sensing waveforms for multiple purposes. For instance, with RADAR waveforms, a UE may leverage a low-cost implementation to achieve high resolution sensing, while a UE and/or a base station may reuse RADAR waveforms for communication purposes, such as beam management. However, from a communications perspective, OFDM may provide implementations for communications with improved spectral efficiency over other waveforms, while from a performance-cost ratio perspective, analog RADAR waveforms may provide higher resolution in RF sensing. Within analog RADAR waveforms, the waveform selection may also impact the RF sensing performance. As one example, at different use cases, operation scenarios, and/or, sensing environments, the RADAR waveform type/parameters may impact the RF sensing performance.

The described aspects for sensing operations, e.g., for waveform adaptations for RF sensing, enable wireless devices and base stations for improved sensing and communications. In one example, a UE may operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The UE may also obtain an indication of a switch to operate in another of the wireless communications mode or the sensing mode, and may further switch to the another of the wireless communications mode or the sensing mode based on the indication. In another example, a base station may operate in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform. The base station may provide, for a UE, an indication of a switch to operate in another of the wireless communications mode or the sensing mode, and may further switch to the another of the wireless communications mode or the sensing mode based on the indication. In aspects, the communications waveform may be an OFDM waveform, and the sensing waveform may be an analog RADAR waveform, and in some aspects, the OFDM waveform and/or the analog RADAR waveform may be used or communications and/or sensing operations.

Particular aspects of the subject matter described in this disclosure can be implemented to realize one or more of the following potential advantages. In some examples, by switching between communication and sensing modes of operation, the described techniques can be used to provide more accurate and efficient sensing data for targets through analog RADAR waveforms, while also providing improved spectral efficiency over other waveforms by utilizing OFDM wave forms for communications. In some examples, by further adapting communication and sensing waveforms, the described techniques can be used to increase accuracy and efficient sensing and communications according to different implementations of UEs/base stations, operating conditions of UEs/base stations, and/or a sensing environment associated with UEs/base stations.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including operating in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform; obtaining an indication of a switch to operate in another of the wireless communications mode or the sensing mode; and switching to the another of the wireless communications mode or the sensing mode based on the indication.

Aspect 2 is the method of aspect 1, where the communications waveform is an orthogonal frequency division multiplexing (OFDM) waveform, and where the sensing waveform is an analog radio detection and ranging (RADAR) waveform.

Aspect 3 is the method of aspect 2, where switching to the another of the wireless communications mode or the sensing mode includes switching from one of the OFDM waveform or the analog RADAR waveform to another of the OFDM waveform or the analog RADAR waveform.

Aspect 4 is the method of any of aspects 1 to 3, where switching to the another of the wireless communications mode or the sensing mode includes switching from the wireless communications mode to the sensing mode, and where obtaining the indication of the switch includes obtaining, via at least one of radio resource control (RRC) signaling, downlink control information (DCI), or a medium access control (MAC) control element (MAC-CE), the indication of the switch, where the indication of the switch includes at least one of a channel associated with the switch, a sensing waveform type, sensing waveform type parameters, or a usage for subsequent transmissions associated with the sensing waveform.

Aspect 5 is the method of any of aspects 1 to 3, where switching to the another of the wireless communications mode or the sensing mode includes switching from the sensing mode to the wireless communications mode, and where obtaining the indication of the switch includes obtaining, via at least one of radio resource control (RRC) signaling, downlink control information (DCI), or a medium access control (MAC) control element (MAC-CE), the indication of the switch, where the indication of the switch includes at least one of a channel associated with the switch, a communications waveform type, communications waveform type parameters, or a usage for subsequent transmissions associated with the communications waveform.

Aspect 6 is the method of any of aspects 1 to 6, where switching to the another of the wireless communications mode or the sensing mode includes at least one of: switching to the another of the wireless communications mode or the sensing mode subsequent to a time gap, where the time gap is associated with, and in addition to, a cyclic prefix (CP) duration and is associated with at least one of transmission switching or reception switching; or switching to the another of the wireless communications mode or the sensing mode during the CP duration and without the time gap.

Aspect 7 is the method of any of aspects 1 to 6, further including: selecting the sensing waveform based on at least one of an implementation of the UE, an operating condition of the UE, or a sensing environment associated with the UE.

Aspect 8 is the method of aspect 7, where selecting the sensing waveform includes selecting the sensing waveform as a continuous wave (CW) linear frequency modulation (LMF) waveform based on a target Doppler that is less than, or less than or equal to, a Doppler threshold.

Aspect 9 is the method of aspect 7, where selecting the sensing waveform includes selecting the sensing waveform as a long unmodulated continuous wave (CW) waveform based on a target Doppler that is greater than, or greater than or equal to, a Doppler threshold.

Aspect 10 is the method of aspect 9, where the Doppler threshold is associated with, and is greater than, a CW linear frequency modulation (LMF) waveform and a short unmodulated CW waveform.

Aspect 11 is the method of aspect 7, where selecting the sensing waveform includes selecting the sensing waveform as a short pulse waveform based on monostatic sensing at the UE.

Aspect 12 is the method of aspect 7, where selecting the sensing waveform includes selecting the sensing waveform from one or more different bands.

Aspect 13 is the method of aspect 12, where selecting the sensing waveform includes selecting the sensing waveform, from one or more different bands based on a cost-performance ratio, as a continuous wave (CW) linear frequency modulation (LMF) waveform in a first band having a first bandwidth or as a pulse waveform in a second band having a second bandwidth, where the first bandwidth is larger than the second bandwidth.

Aspect 14 is the method of aspect 7, where selecting the sensing waveform includes selecting the sensing waveform as a continuous wave (CW) linear frequency modulation (LMF) waveform for an outdoor environment or as a pulse waveform in an indoor environment.

Aspect 15 is the method of any of aspects 7 to 14, further including: obtaining adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE; where selecting the sensing waveform includes selecting the sensing waveform based on the adaptation information.

Aspect 16 is the method of aspect 15, where obtaining the adaptation information includes receiving at least a portion of the adaptation information from a network node, where the at least one adaptation factor includes at least one of a first distribution for target parameters, a dynamic range of the target parameters, clutter in the sensing environment, a power spectral density of the clutter, a second distribution or a dynamic range of a delay spread of the clutter, or a radio access technology (RAT).

Aspect 17 is a method of wireless communication at a network node, including: operating in one of a wireless communications mode or a sensing mode, where the wireless communications mode is associated with at least one of a communications waveform or a sensing waveform, where the sensing mode is associated with at least one of the communications waveform or the sensing waveform, and where the sensing waveform is different from the communications waveform; providing, for a user equipment (UE), an indication of a switch to operate in another of the wireless communications mode or the sensing mode; and switching to the another of the wireless communications mode or the sensing mode based on the indication.

Aspect 18 is the method of aspect 17, where the communications waveform is an orthogonal frequency division multiplexing (OFDM) waveform, and where the sensing waveform is an analog radio detection and ranging (RADAR) waveform.

Aspect 19 is the method of aspect 18, where switching to the another of the wireless communications mode or the sensing mode includes switching from one of the OFDM waveform or the analog RADAR waveform to another of the OFDM waveform or the analog RADAR waveform.

Aspect 20 is the method of any of aspects 17 to 19, where switching to the another of the wireless communications mode or the sensing mode includes switching from the wireless communications mode to the sensing mode, and where providing the indication of the switch includes providing, via at least one of radio resource control (RRC) signaling, downlink control information (DCI), or a medium access control (MAC) control element (MAC-CE), the indication of the switch, where the indication of the switch includes at least one of a channel associated with the switch, a sensing waveform type, sensing waveform type parameters, or a usage for subsequent transmissions associated with the sensing waveform.

Aspect 21 is the method of any of aspects 17 to 19, where switching to the another of the wireless communications mode or the sensing mode includes switching from the sensing mode to the wireless communications mode, and where providing the indication of the switch includes providing, via at least one of radio resource control (RRC) signaling, downlink control information (DCI), or a medium access control (MAC) control element (MAC-CE), the indication of the switch, where the indication of the switch includes at least one of a channel associated with the switch, a communications waveform type, communications waveform type parameters, or a usage for subsequent transmissions associated with the communications waveform. Aspect 22 is the method of any of aspects 17 to 21, where switching to the another of the wireless communications mode or the sensing mode includes at least one of: switching to the another of the wireless communications mode or the sensing mode subsequent to a time gap, where the time gap is associated with, and in addition to, a cyclic prefix (CP) duration and is associated with at least one of transmission switching or reception switching; or switching to the another of the wireless communications mode or the sensing mode during the CP duration and without the time gap.

Aspect 23 is the method of any of aspects 17 to 22, further including: selecting the sensing waveform based on at least one of an implementation of the UE, an operating condition of the UE, or a sensing environment associated with the UE.

Aspect 24 is the method of aspect 23, where selecting the sensing waveform includes at least one of: selecting the sensing waveform as a continuous wave (CW) linear frequency modulation (LMF) waveform based on a target Doppler being less than, or less than or equal to, a first Doppler threshold; or selecting the sensing waveform as a long unmodulated CW waveform based on the target Doppler being greater than, or greater than or equal to, a second Doppler threshold.

Aspect 25 is the method of aspect 24, where the second Doppler threshold is associated with, and is greater than, a CW LMF waveform and a short unmodulated CW waveform.

Aspect 26 is the method of aspect 23, where selecting the sensing waveform includes at least one of: selecting the sensing waveform as a short pulse waveform based on mono-static sensing at the UE; selecting the sensing waveform from one or more different bands; or selecting the sensing waveform, from the one or more different bands based on a cost-performance ratio, as a continuous wave (CW) linear frequency modulation (LMF) waveform in a first band having a first bandwidth or as a pulse waveform in a second band having a second bandwidth, where the first bandwidth is larger than the second bandwidth.

Aspect 27 is the method of aspect 23, where selecting the sensing waveform includes selecting the sensing waveform as a continuous wave (CW) linear frequency modulation (LMF) waveform for an outdoor environment or as a pulse waveform in an indoor environment.

Aspect 28 is the method of any of aspects 23 to 27, further including: providing adaptation information, where the adaptation information is based on at least one adaptation factor associated with one or more of the sensing environment, sensing target characteristics, a hardware capability of the UE, a power budget of the UE, a transmission power capability of the UE, or a maximum power emission for the UE, and where the at least one adaptation factor includes at least one of a first distribution for target parameters, a dynamic range of the target parameters, clutter in the sensing environment, a power spectral density of the clutter, a second distribution or a dynamic range of a delay spread of the clutter, or a radio access technology (RAT); where selecting the sensing waveform includes selecting the sensing waveform based on the adaptation information.

Aspect 29 is an apparatus for wireless communication including means for implementing any of aspects 1 to 16.

Aspect 30 is a computer-readable medium (e.g., a non-transitory computer-readable medium) storing computer executable code, the code when executed by at least one processor causes the at least one processor to implement any of aspects 1 to 16.

Aspect 31 is an apparatus for wireless communication at a network node. The

apparatus includes a memory; and at least one processor coupled to the memory and, based at least in part on information stored in the memory, the at least one processor is configured to implement any of aspects 1 to 16.

Aspect 32 is the apparatus of aspect 31, further including at least one of a transceiver or an antenna coupled to the at least one processor.

Aspect 33 is an apparatus for wireless communication including means for implementing any of aspects 17 to 28.

Aspect 34 is a computer-readable medium (e.g., a non-transitory computer-readable medium) storing computer executable code, the code when executed by at least one processor causes the at least one processor to implement any of aspects 17 to 28.

Aspect 35 is an apparatus for wireless communication at a network node. The apparatus includes a memory; and at least one processor coupled to the memory and, based at least in part on information stored in the memory, the at least one processor is configured to implement any of aspects 17 to 28.

Aspect 36 is the apparatus of aspect 35, further including at least one of a transceiver or an antenna coupled to the at least one processor.

What is claimed is:

1. An apparatus for wireless communication at a user equipment (UE), comprising:
a memory; and
at least one processor coupled to the memory and, based at least in part on information stored in the memory, the at least one processor is configured to:
operate in one of a wireless communications mode or a sensing mode, wherein the wireless communications mode is associated with at least one of a communications waveform or a sensing waveform, wherein the sensing mode is associated with at least one of the communications waveform or the sensing waveform, and wherein the sensing waveform is different from the communications waveform;
obtain an indication of a switch to operate in another of the wireless communications mode or the sensing mode; and
switch to the another of the wireless communications mode or the sensing mode based on the indication.

2. The apparatus of claim 1, wherein the communications waveform is an orthogonal frequency division multiplexing (OFDM) waveform, and wherein the sensing waveform is an analog radio detection and ranging (RADAR) waveform.

3. The apparatus of claim 2, wherein to switch to the another of the wireless communications mode or the sensing mode, the at least one processor is configured to switch from one of the OFDM waveform or the analog RADAR waveform to another of the OFDM waveform or the analog RADAR waveform.

4. The apparatus of claim 1, wherein to switch to the another of the wireless communications mode or the sensing mode, the at least one processor is configured to switch from the wireless communications mode to the sensing mode, and
wherein to obtain the indication of the switch, the at least one processor is configured to obtain, via at least one of radio resource control (RRC) signaling, downlink control information (DCI), or a medium access control (MAC) control element (MAC-CE), the indication of the switch, wherein the indication of the switch includes at least one of a channel associated with the switch, a sensing waveform type, sensing waveform type parameters, or a usage for subsequent transmissions associated with the sensing waveform.

5. The apparatus of claim 1, wherein to switch to the another of the wireless communications mode or the sensing mode, the at least one processor is configured to switch from the sensing mode to the wireless communications mode, and
wherein to obtain the indication of the switch, the at least one processor is configured to obtain, via at least one of radio resource control (RRC) signaling, downlink control information (DCI), or a medium access control (MAC) control element (MAC-CE), the indication of the switch, wherein the indication of the switch includes at least one of a channel associated with the switch, a communications waveform type, communications waveform type parameters, or a usage for subsequent transmissions associated with the communications waveform.

6. The apparatus of claim 1, wherein to switch to the another of the wireless communications mode or the sensing mode, the at least one processor is configured to at least one of:
switch to the another of the wireless communications mode or the sensing mode subsequent to a time gap, wherein the time gap is associated with, and in addition to, a cyclic prefix (CP) duration and is associated with at least one of transmission switching or reception switching; or
switch to the another of the wireless communications mode or the sensing mode during the CP duration and without the time gap.

7. The apparatus of claim 1, wherein the at least one processor is further configured to:
select the sensing waveform based on at least one of an implementation of the UE, an operating condition of the UE, or a sensing environment associated with the UE.

8. The apparatus of claim 7, wherein to select the sensing waveform, the at least one processor is configured to select the sensing waveform as a continuous wave (CW) linear frequency modulation (LMF) waveform based on a target Doppler that is less than, or less than or equal to, a Doppler threshold.

9. The apparatus of claim 7, wherein to select the sensing waveform, the at least one processor is configured to select the sensing waveform as a long unmodulated continuous wave (CW) waveform based on a target Doppler that is greater than, or greater than or equal to, a Doppler threshold.

10. The apparatus of claim 9, wherein the Doppler threshold is associated with, and is greater than, a CW linear frequency modulation (LMF) waveform and a short unmodulated CW waveform.

11. The apparatus of claim 7, wherein to select the sensing waveform, the at least one processor is configured to select the sensing waveform as a short pulse waveform based on monostatic sensing at the UE.

12. The apparatus of claim 7, wherein to select the sensing waveform, the at least one processor is configured to select the sensing waveform from one or more different bands.

13. The apparatus of claim 7, wherein to select the sensing waveform, the at least one processor is configured to select the sensing waveform, from one or more different bands based on a cost-performance ratio, as a continuous wave (CW) linear frequency modulation (LMF) waveform in a first band having a first bandwidth or as a pulse waveform in a second band having a second bandwidth, wherein the first bandwidth is larger than the second bandwidth.

14. The apparatus of claim 7, wherein to select the sensing waveform, the at least one processor is configured to select the sensing waveform as a continuous wave (CW) linear frequency modulation (LMF) waveform for an outdoor environment or as a pulse waveform in an indoor environment.

15. The apparatus of claim 7, wherein the at least one processor is further configured to:
obtain adaptation information, wherein the adaptation information is based on at least one adaptation factor associated with one or more of the sensing environment, sensing target characteristics, a hardware capability of the UE, a power budget of the UE, a transmission power capability of the UE, or a maximum power emission for the UE;
wherein to select the sensing waveform, the at least one processor is configured to select the sensing waveform based on the adaptation information.

16. The apparatus of claim 15, wherein to obtain the adaptation information, the at least one processor is configured to receive at least a portion of the adaptation information from a network node, wherein the at least one adaptation factor includes at least one of a first distribution for target parameters, a dynamic range of the target parameters, clutter in the sensing environment, a power spectral density of the clutter, a second distribution or a dynamic range of a delay spread of the clutter, or a radio access technology (RAT).

17. An apparatus for wireless communication at a network node, comprising:
a memory; and
at least one processor coupled to the memory and, based at least in part on information stored in the memory, the at least one processor is configured to:
operate in one of a wireless communications mode or a sensing mode, wherein the wireless communications mode is associated with at least one of a communications waveform or a sensing waveform, wherein the sensing mode is associated with at least one of the communications waveform or the sensing waveform, and wherein the sensing waveform is different from the communications waveform;
provide, for a user equipment (UE), an indication of a switch to operate in another of the wireless communications mode or the sensing mode; and
switch to the another of the wireless communications mode or the sensing mode based on the indication.

18. The apparatus of claim 17, wherein the communications waveform is an orthogonal frequency division multiplexing (OFDM) waveform, and wherein the sensing waveform is an analog radio detection and ranging (RADAR) waveform.

19. The apparatus of claim 18, wherein to switch to the another of the wireless communications mode or the sensing mode, the at least one processor is configured to switch from one of the OFDM waveform or the analog RADAR waveform to another of the OFDM waveform or the analog RADAR waveform.

20. The apparatus of claim 17, wherein to switch to the another of the wireless communications mode or the sensing mode, the at least one processor is configured to switch from the wireless communications mode to the sensing mode, and
wherein to provide the indication of the switch, the at least one processor is configured to provide, via at least one of radio resource control (RRC) signaling, downlink control information (DCI), or a medium access control (MAC) control element (MAC-CE), the indication of the switch, wherein the indication of the switch includes at least one of a channel associated with the switch, a sensing waveform type, sensing waveform type parameters, or a usage for subsequent transmissions associated with the sensing waveform.

21. The apparatus of claim 17, wherein to switch to the another of the wireless communications mode or the sensing mode, the at least one processor is configured to switch from the sensing mode to the wireless communications mode, and
wherein to provide the indication of the switch, the at least one processor is configured to provide, via at least one of radio resource control (RRC) signaling, downlink control information (DCI), or a medium access control (MAC) control element (MAC-CE), the indication of the switch, wherein the indication of the switch includes at least one of a channel associated with the switch, a communications waveform type, communications waveform type parameters, or a usage for subsequent transmissions associated with the communications waveform.

22. The apparatus of claim 17, wherein to switch to the another of the wireless communications mode or the sensing mode, the at least one processor is configured to at least one of:
switch to the another of the wireless communications mode or the sensing mode subsequent to a time gap, wherein the time gap is associated with, and in addition to, a cyclic prefix (CP) duration and is associated with at least one of transmission switching or reception switching; or
switch to the another of the wireless communications mode or the sensing mode during the CP duration and without the time gap.

23. The apparatus of claim 17, wherein the at least one processor is further configured to:
select the sensing waveform based on at least one of an implementation of the UE, an operating condition of the UE, or a sensing environment associated with the UE.

24. The apparatus of claim 23, wherein to select the sensing waveform, the at least one processor is configured to at least one of:
select the sensing waveform as a continuous wave (CW) linear frequency modulation (LMF) waveform based on a target Doppler being less than, or less than or equal to, a first Doppler threshold; or
select the sensing waveform as a long unmodulated CW waveform based on the target Doppler being greater than, or greater than or equal to, a second Doppler threshold.

25. The apparatus of claim 24, wherein the second Doppler threshold is associated with, and is greater than, a CW LMF waveform and a short unmodulated CW waveform.

26. The apparatus of claim 23, wherein to select the sensing waveform, the at least one processor is configured to at least one of:
select the sensing waveform as a short pulse waveform based on mono-static sensing at the UE;
select the sensing waveform from one or more different bands; or
select the sensing waveform, from the one or more different bands based on a cost-performance ratio, as a continuous wave (CW) linear frequency modulation (LMF) waveform in a first band having a first bandwidth or as a pulse waveform in a second band having a second bandwidth, wherein the first bandwidth is larger than the second bandwidth.

27. The apparatus of claim 23, wherein to select the sensing waveform, the at least one processor is configured to select the sensing waveform as a continuous wave (CW) linear frequency modulation (LMF) waveform for an outdoor environment or as a pulse waveform in an indoor environment.

28. The apparatus of claim 23, wherein the at least one processor is further configured to:
provide adaptation information, wherein the adaptation information is based on at least one adaptation factor associated with one or more of the sensing environment, sensing target characteristics, a hardware capability of the UE, a power budget of the UE, a transmission power capability of the UE, or a maximum power emission for the UE, and wherein the at least one adaptation factor includes at least one of a first distribution for target parameters, a dynamic range of the target parameters, clutter in the sensing environment, a power spectral density of the clutter, a second distribution or a dynamic range of a delay spread of the clutter, or a radio access technology (RAT);
wherein to select the sensing waveform, the at least one processor is configured to select the sensing waveform based on the adaptation information.

29. A method of wireless communication at a user equipment (UE), comprising:
operating in one of a wireless communications mode or a sensing mode, wherein the wireless communications mode is associated with at least one of a communications waveform or a sensing waveform, wherein the sensing mode is associated with at least one of the communications waveform or the sensing waveform, and wherein the sensing waveform is different from the communications waveform;
obtaining an indication of a switch to operate in another of the wireless communications mode or the sensing mode; and
switching to the another of the wireless communications mode or the sensing mode based on the indication.

30. A method of wireless communication at a network node, comprising:
operating in one of a wireless communications mode or a sensing mode, wherein the wireless communications mode is associated with at least one of a communications waveform or a sensing waveform, wherein the sensing mode is associated with at least one of the communications waveform or the sensing waveform, and wherein the sensing waveform is different from the communications waveform;
providing, for a user equipment (UE), an indication of a switch to operate in another of the wireless communications mode or the sensing mode; and
switching to the another of the wireless communications mode or the sensing mode based on the indication.
